(19) United States
(12) Patent Application Publication
(10) Pub. No.: US 2026/0332893 A1
(43) Pub. Date: Oct. 22, 2026

(54) IMAGE PROCESSING DEVICE, METHOD FOR CONTROLLING IMAGE PROCESSING DEVICE, AND STORAGE MEDIUM

(71) Applicant: CANON KABUSHIKI KAISHA, Tokyo (JP)

(72) Inventors: RYOTA KOMATSU, Tokyo (JP); MASAKAZU FUJIKI, Kanagawa (JP); ATSUSHI NOGAMI, Kanagawa (JP)

(21) Appl. No.: 19/468,813

(22) Filed: Feb. 3, 2026

(30) Foreign Application Priority Data
Feb. 10, 2025 (JP) 2025-020340

(51) Int. Cl. H04N 23/67

(52) U.S. Cl. CPC H04N 23/676; H04N 23/672

(57) ABSTRACT

In a processing device, range information indicating a range of defocus amounts corresponding to a plurality of subject parts being subjected to image capturing is acquired, a plurality of image capturing conditions for capturing images in which the plurality of subject parts are in focus are set based on the range information, and a plurality of times of image capturing are performed based on the plurality of image capturing conditions.

### BACKGROUND

### Field of the Technology

The aspect of the embodiments relates to an image processing device, a method for controlling an image processing device, a storage medium, and the like.

### Description of the Related Art

In the related art, there is a technology of setting an in-focus position on the basis of a defocus amount of a part of a subject. Japanese Patent Laid-Open No. 2016-40578 discloses a technology of performing focus bracket image capturing by providing a plurality of ranging points within a captured image and setting an in-focus position during image capturing on the basis of defocus values at the ranging points.

In the configuration of Japanese Patent Laid-Open No. 2016-40578, if the in-focus position is set from the defocus amount corresponding to one point in a subject part, when the defocus amount varies depending on the portion of the subject part, image capturing may be performed in a state in which an out-of-focus portion exists in this subject part.

In this way, if image capturing is performed in a state in which an out-of-focus portion exists in a subject part, it has been difficult to capture images in which a plurality of such subject parts are in focus when a plurality of subject parts are targeted for image capturing.

### SUMMARY

A processing device acquires range information indicating a range of defocus amounts corresponding to a plurality of subject parts being subjected to image capturing, sets a plurality of image capturing conditions for capturing images in which the plurality of subject parts are in focus based on the range information, and performs a plurality of times of image capturing based on the plurality of image capturing conditions.

Further features of the disclosure will become apparent from the following description of embodiments with reference to the attached drawings.

### BRIEF DESCRIPTION OF THE DRAWINGS

FIG. 1 is a diagram showing an example of a hardware configuration of an image capturing device.

FIG. 2 is an explanatory view of an example of a relationship between a defocus amount of an image capturing optical system in the image capturing device and a phase difference of a focus detection signal acquired from an image capturing element.

FIG. 3A is a view showing an example of a relationship between the image capturing device and a subject person, and FIG. 3B is a diagram showing an example of defocus ranges of the pupils, the face, and the torso of a person.

FIG. 4 is a diagram showing an example of a functional configuration of the image capturing device.

FIG. 5A is a diagram showing an example of a configuration of all subject information, and FIG. 5B is a diagram showing an example of a configuration of subject information.

FIG. 6 is a flowchart showing an example of a flow of condition image capturing processing.

FIG. 7 is a flowchart showing an example of a flow of condition setting processing.

FIG. 8 is a flowchart showing an example of a flow of bracket image capturing processing.

FIG. 9 is a view showing an example of a captured image.

FIG. 10 is a diagram showing an example of a relationship between subjects and image capturing conditions for bracket image capturing set in a condition setting unit.

FIG. 11 is a flowchart showing another example of a flow of the condition setting processing.

FIG. 12 is a flowchart showing another example of a flow of the bracket image capturing processing.

FIG. 13 is a diagram showing another example of a relationship between the subjects and the image capturing conditions for the bracket image capturing set by the condition setting unit.

FIG. 14 is a diagram showing another example of a relationship between the subjects and the image capturing conditions for the bracket image capturing set by the condition setting unit.

FIG. 15 is a flowchart showing another example of a flow of the condition setting processing.

FIG. 16 is a flowchart showing another example of a flow of the condition setting processing.

FIG. 17 is a flowchart showing another example of a flow of the condition setting processing.

FIG. 18 is a flowchart showing an example of a flow of change processing.

FIG. 19 is a diagram showing an example of a relationship between an in-focus position set for an adult male and an in-focus position set for a child in a captured image.

FIG. 20 is a diagram showing an example of a setting screen.

FIG. 21 is a flowchart showing another example of a flow of the condition setting processing.

FIG. 22 is a flowchart showing another example of a flow of the bracket image capturing processing.

FIG. 23 is a flowchart showing another example of a flow of the condition setting processing

FIG. 24 is a flowchart showing another example of a flow of the bracket image capturing processing.

FIG. 25 is a diagram showing another example of a relationship between the subjects and the image capturing conditions for the bracket image capturing set by the condition setting unit.

FIG. 26 is a flowchart showing another example of a flow of the condition image capturing processing.

FIG. 27 is a flowchart showing another example of a flow of the condition setting processing.

FIG. 28 is a flowchart showing another example of a flow of the bracket image capturing processing.

FIG. 29 is a diagram showing another example of a relationship between the subjects and the image capturing conditions for the bracket image capturing set by the condition setting unit.

### DESCRIPTION OF THE EMBODIMENTS

Hereinafter, with reference to the accompanying drawings, favorable modes of the disclosure will be described using Embodiments. In each diagram, the same reference signs are applied to the same members or elements, and duplicate description will be omitted or simplified.

### First Embodiment

Hereinafter, embodiments of the disclosure will be described with reference to the drawings.

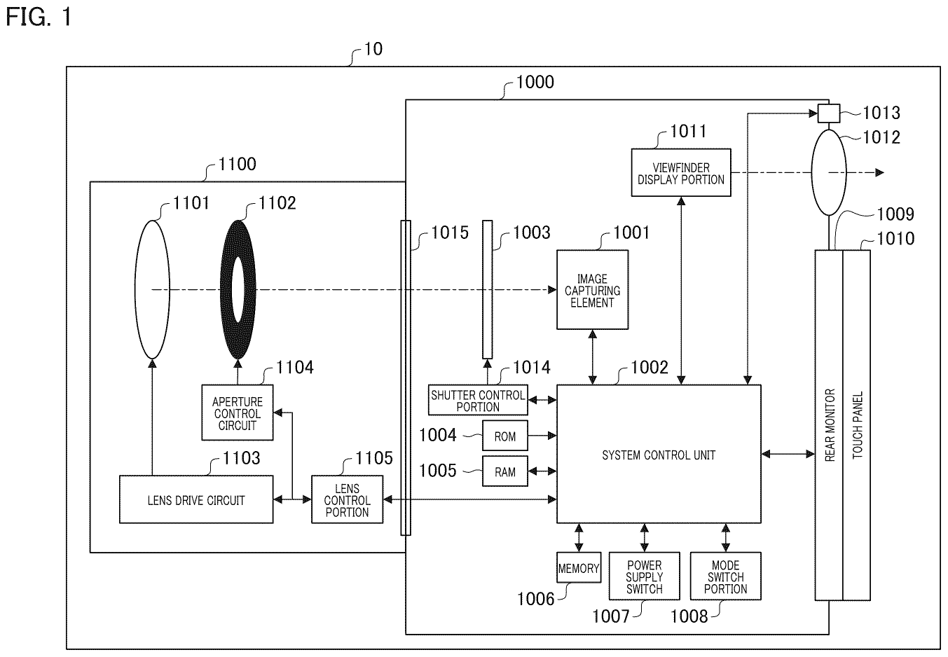

FIG. 1 is a diagram showing an example of a hardware configuration of an image capturing device 10. The image capturing device 10 of the Embodiment performs image capturing by estimating a defocus range for each part of a subject and setting an in-focus position on the basis of the estimated defocus range. The defocus range is a range of a defocus amount. It is assumed that the image capturing device 10 of the Embodiment is a mirrorless single-lens reflex camera.

The image capturing device 10, which is an example of an image processing device, includes a camera main body 1000 and a lens unit 1100. The camera main body 1000 and the lens unit 1100 are connected via a lens mount mechanism 1015.

The camera main body 1000 has an image capturing element 1001, a system control unit 1002, a shutter 1003, a ROM 1004, a RAM 1005, a memory 1006, a power supply switch 1007, a mode switch portion 1008, a rear monitor 1009, and a touch panel 1010.

In addition, the camera main body 1000 has a viewfinder display portion 1011, an eyepiece 1012, and an eyepiece detection portion 1013.

The image capturing element 1001 converts an optical signal (optical image) into an electrical signal. Examples of the image capturing element 1001 include a CMOS-type imaging sensor.

The system control unit 1002 controls the camera main body 1000. The system control unit 1002 performs image processing with respect to a video signal generated by the image capturing element 1001. In addition, the system control unit 1002 performs focus detection processing using a phase difference detection method on the basis of an image for focus detection (signal for a phase difference AF).

More specifically, the system control unit 1002 generates, as an image for focus detection, a pair of pieces of image data formed by a light beam passing through a pair of pupil areas of an image capturing optical system. The system control unit 1002 detects the focus deviation amount on the basis of the deviation amount between a pair of pieces of image data.

In this way, the system control unit 1002 performs the phase difference AF (image capturing plane phase difference AF) based on an output of the image capturing element 1001 without using a dedicated AF sensor. The system control unit 1002 has a CPU.

The ROM 1004 records programs for controlling operation of the camera main body 1000, machine learning models after learning, and the like. The RAM 1005 records setting values such as variables required for operation of the camera main body 1000, various parameters, and an ISO sensitivity; thresholds for image selection set in advance; live view images acquired during control; image capturing modes; various kinds of correction data; and the like.

The memory 1006 is a removable flash memory which records captured images, incidental information linked to the captured images, and the like. The power supply switch 1007 switches between power on and off modes of the camera main body 1000. The mode switch portion 1008 is a switch for switching between various image capturing modes, such as live view image capturing and video image capturing.

The rear monitor 1009 displays image capturing information such as text, captured images, operational statuses of audio and the like, and messages in response to execution of a program by the system control unit 1002. Examples of the rear monitor 1009 include a liquid crystal device and an LED.

The touch panel 1010 is disposed in an area substantially equivalent to that of the rear monitor 1009, detects contact with a finger or a pen, and notifies the system control unit 1002 of the contact position on the rear monitor 1009, thereby executing an operation or a function associated with the contact position.

The viewfinder display portion 1011 displays, similarly to the rear monitor 1009, image capturing information in response to execution of a program by the system control unit 1002 and constitutes an electronic viewfinder (EVF) together with the eyepiece 1012.

When approach of an image-capturer to the eyepiece is detected, the eyepiece detection portion 1013 causes the rear monitor 1009 or the viewfinder display portion 1011, via the system control unit 1002, to selectively display the image capturing information described above in accordance with the detected eyepiece state.

The lens unit 1100 guides incident light to the image capturing element 1001. The lens unit 1100 is removable with respect to the camera main body 1000. The lens unit 1100 has an image capturing lens 1101, an aperture 1102, a lens drive circuit 1103, an aperture control circuit 1104, and a lens control portion 1105.

A ray of light incident on the image capturing lens 1101 goes through the aperture 1102 and the shutter 1003 of the camera main body 1000 and forms an image (optical image) in the image capturing element 1001. FIG. 1 shows only one image capturing lens 1101, but the lens unit 1100 may be provided with any number of image capturing lenses 1101.

The lens control portion 1105 controls the lens unit 1100 in its entirety. The lens control portion 1105 includes a memory which stores various constants for lens operation, variables, programs, and the like. In addition, the lens control portion 1105 includes a non-volatile memory which retains information unique to the lens unit 1100, such as a maximum aperture value, a minimum aperture value, and a focal length.

The system control unit 1002 of the camera main body 1000 computes the defocus amount using output information of the image capturing element 1001. In addition, the system control unit 1002 performs communication via the lens control portion 1105 of the lens unit 1100 on the basis of the computed defocus amount, and adjusts the focus by controlling the lens drive circuit 1103.

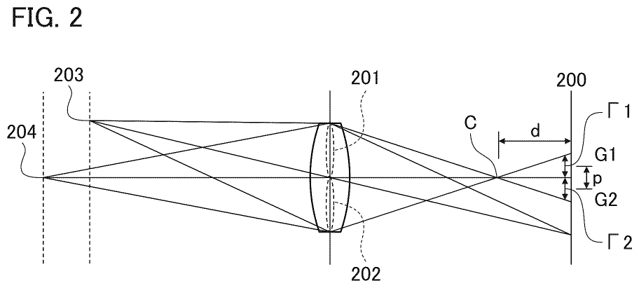

Next, the defocus amount will be described. FIG. 2 is an explanatory view of an example of a relationship between the defocus amount of the image capturing optical system in the image capturing device 10 and a phase difference (image deviation amount) of a focus detection signal acquired from the image capturing element 1001.

FIG. 2 shows an image capturing plane 200 of the image capturing element 1001, a subject 203, a subject 204, and an image formation position C of light beams from the subjects. In addition, an emission pupil of the image capturing optical system is divided into a first pupil area 201 and a second pupil area 202.

A defocus amount d is a distance from the image formation position C to the image capturing plane 200. In addition, in a front-focus state in which the image formation position C is on the subject side with respect to the image capturing plane 200, the defocus amount is represented by a negative value (d<0).

In addition, in a rear-focus state in which the image formation position Cis on a side opposite to the subject with respect to the image capturing plane 200, the defocus amount is represented by a positive value (d>0). In addition, in an in-focus state in which the image formation position C is on the image capturing plane 200, the defocus amount d is zero.

Either the front-focus state or the rear-focus state described above, in other words, a state in which the defocus amount is not zero, will be referred to as a defocus state. In the example shown in FIG. 2, the image capturing optical system is in the in-focus state with respect to the subject 203 and in the front-focus state with respect to the subject 204.

In the front-focus state, a light beam, of the light beams from the subject 204, which has passed through the first pupil area 201 (second pupil area 202) is first condensed and then spreads to a width Γ1 (Γ2) centered on a center of gravity position G1 (G2) of the light beam and forms a blurred image on the image capturing plane 200.

This blurred image is received by each first focus detection pixel (second focus detection pixel) in the image capturing element 1001, and a first focus detection signal (second focus detection signal) is generated. Namely, the first focus detection signal (second focus detection signal) is a signal representing a subject image of the subject 204 blurred by the blur width Γ1 (Γ2) at the center of gravity position G1 (G2) of the light beam on the image capturing plane 200.

The blur width Γ1 (Γ2) of the subject image increases approximately in proportion to the increase in the absolute value of the defocus amount d. Similarly, the magnitude of an image deviation amount p between the first focus detection signal and the second focus detection signal (difference between the center of gravity position G1 of the light beam and the center of gravity position G2 of the light beam) also increases approximately in proportion to the increase in the absolute value of the defocus amount d.

In addition, in the rear-focus state, the direction of image deviation between the first focus detection signal and the second focus detection signal is opposite to that in the front-focus state. However, the relationship between the blur width Γ1 (Γ2) of the subject image and the defocus amount d, and the relationship between the image deviation amount p and the defocus amount d are the same as those in the front-focus state.

The system control unit 1002 of the Embodiment performs focus detection using a so-called image capturing plane phase difference detection method, in which the defocus amount d is calculated from the image deviation amount p described above.

For this reason, the system control unit 1002 converts the image deviation amount p into the defocus amount d using a conversion coefficient calculated on the basis of a reference line length from the relationship between the defocus amount d of an image capturing signal and the image deviation amount p.

In addition, in the Embodiment, a product [Fδ] of an aperture F-value in the image capturing optical system during image capturing and a diameter δ of a permissible circle of confusion is used as the unit of the defocus amount.

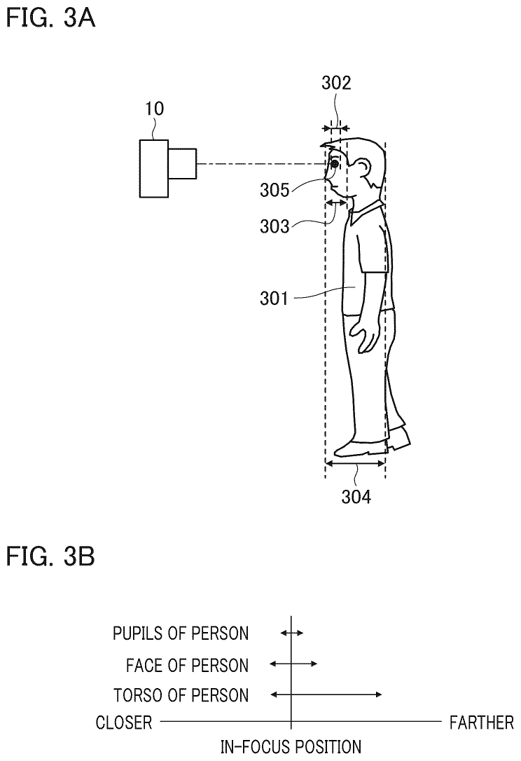

Next, the defocus range will be described. FIG. 3A is a view showing an example of a relationship between the image capturing device 10 and a subject person 301. The lateral direction in FIG. 3A corresponds to the depth direction with respect to a camera 100. For this reason, the lateral direction in FIG. 3A may hereinafter simply be referred to as the depth direction.

FIG. 3A shows pupils 302, a face 303, and a torso 304 as parts of the person 301. The pupils 302, the face 303, and the torso 304 are all parts having a range in the depth direction.

In addition, FIG. 3A shows an in-focus position 305 of the image capturing device 10. In the shown example, the in-focus position 305 corresponds to the pupils 302 of the person 301.

FIG. 3B is a diagram showing an example of defocus ranges of the pupils 302, the face 303, and the torso 304 of the person 301. In FIG. 3B, “IN-FOCUS POSITION” means the in-focus position 305 shown in FIG. 3A, “CLOSER” means a position closer to the image capturing device 10 side than “IN-FOCUS POSITION”, and “FARTHER” means a position closer to the side opposite to the image capturing device 10 with respect to “IN-FOCUS POSITION”.

In addition, in FIG. 3B, the horizontal axis with respect to “IN-FOCUS POSITION” means the defocus amount, and the length of the arrow extending in the horizontal direction means the defocus range.

In the depth direction, a portion of the torso 304 on the closest side is a portion of the tip of the nose of the person 301, and a portion of the torso 304 on the farthest side is a portion of the shoulder of the person 301. For this reason, the maximum value of the defocus amount in the torso 304 is the defocus amount in the portion of the tip of the nose of the person 301, and the minimum value of the defocus amount in the torso 304 is the defocus amount in the portion of the shoulder of the person 301.

Further, in this case, a range from the defocus amount in the portion of the tip of the nose of the person 301 to the defocus amount in the portion of the shoulder of the person 301 is the defocus range for the torso 304 of the person 301.

FIG. 3B shows not only the defocus range for the torso 304 but also the defocus range for the pupils 302 and the defocus range for the face 303. Here, the face 303 has a smaller defocus range than the torso 304.

Additionally, the face 303 has a smaller defocus range than the torso 304 by the amount corresponding to the smaller range in the depth direction. In addition, the pupils 302 have a smaller defocus range than the face 303.

A target portion in a subject for which the defocus range is identified is not limited to the portion described above. In addition, a target subject for which the defocus range is identified is not limited to a person.

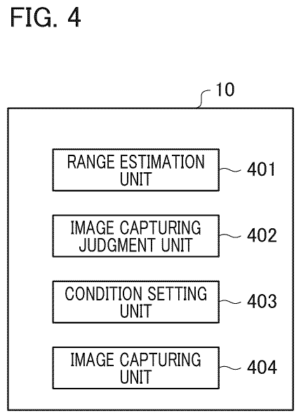

FIG. 4 is a diagram showing an example of a functional configuration of the image capturing device 10. As shown in FIG. 4, the image capturing device 10 includes a range estimation unit 401, an image capturing judgment unit 402, a condition setting unit 403, and an image capturing unit 404.

The range estimation unit 401, which is an example of an acquisition means, estimates the defocus range for a subject on the basis of captured images recorded in the memory 1006. For this reason, the range estimation unit 401 can also be regarded as an estimation means for estimating the range of the defocus amount.

The range estimation unit 401 transmits information indicating the estimated defocus range to the condition setting unit 403. The information indicating the defocus range estimated by the range estimation unit 401 may hereinafter be referred to as range information.

The image capturing judgment unit 402, which is an example of a judgment means, judges whether or not to perform bracket image capturing using the image capturing device 10 on the basis of the range information generated by the range estimation unit 401.

The condition setting unit 403, which is an example of a setting means, sets image capturing conditions of the image capturing device 10 on the basis of information indicating the defocus range acquired from the range estimation unit 401. The condition setting unit 403 transmits the information indicating the set image capturing conditions to the image capturing unit 404. The information indicating the image capturing conditions set by the condition setting unit 403 may hereinafter be referred to as image capturing condition information.

The image capturing unit 404, which is an example of an image capturing means, performs image capturing on the basis of the image capturing condition information acquired from the condition setting unit 403. For example, the range estimation unit 401, the image capturing judgment unit 402, and the condition setting unit 403 are realized by the system control unit 1002.

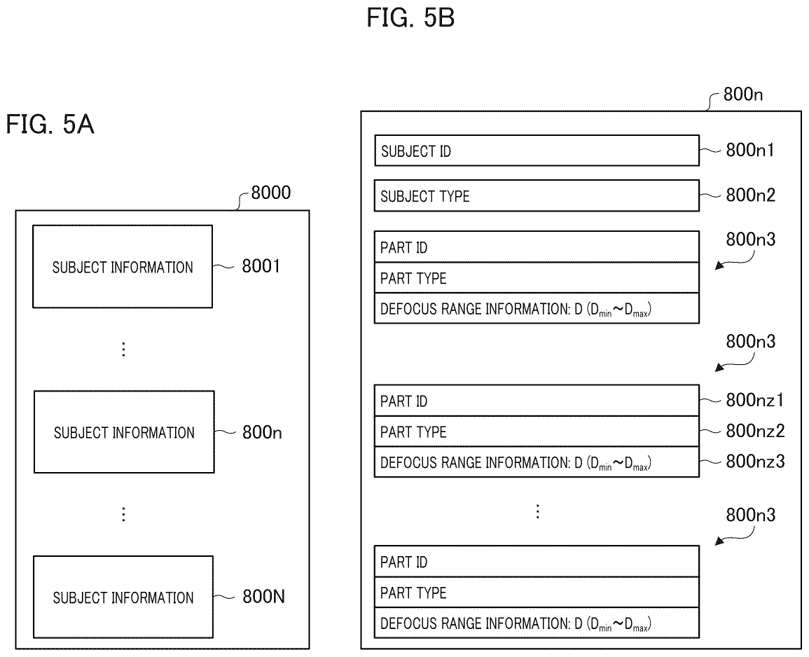

FIG. 5A is a diagram showing an example of a configuration of all subject information 8000. The all subject information 8000 is information on all subjects appearing in a captured image. The all subject information 8000 includes subject information.

In the example shown in FIG. 5A, since the number of subjects appearing in the captured image is N, the all subject information 8000 includes N pieces of subject information of subject information 8001 to subject information 800N.

FIG. 5B is a diagram showing an example of a configuration of a subject information 800n shown in FIG. 5A. The subject information 800n indicates a subject ID 800n1, a subject type 800n2, and part information 800n3.

The subject ID 800n1 indicates information identifying the subject. The subject type 800n2 indicates the type of the subject. The part information 800n3 indicates information related to the part of the subject.

The subject information 800n is provided with the part information 800n3 for each part of the subject targeted for the range information. Each piece of the part information 800n3 indicates a part ID 800nz1, a part type 800nz2, and range information 800nz3.

The target part whose information is indicated in the part information 800n3 may hereinafter be referred to as a target part. The target part can also be regarded as a target part for which the defocus range is estimated by the range estimation unit 401.

The part ID 800nz1 indicates information identifying the target part. The part type 800nz2 indicates the type of the target part. The range information 800nz3 indicates the range information of the target part generated by the range estimation unit 401 (refer to FIG. 4).

In the shown example, in the range information 800nz3, the defocus amount in a portion on the closest side in the target parts is indicated as a minimum value Dmin, and the defocus amount in a portion on the farthest side in the target parts is indicated as a maximum value Dmax. Further, this range from the minimum value Dmin to the maximum value Dmax is indicated as a defocus range D.

The defocus amount of each part of the subject varies depending on which position the in-focus position is. For this reason, the range information 800nz3 may include information indicating which position the in-focus position is.

In addition, instead of the information indicating which position the in-focus position is, the range information 800nz3 may include information indicating which position an image formation position is. By doing this, a position corresponding to the portion where the defocus amount is the minimum value Dmin and a position corresponding to the portion where the defocus amount is the maximum value Dmax are identified.

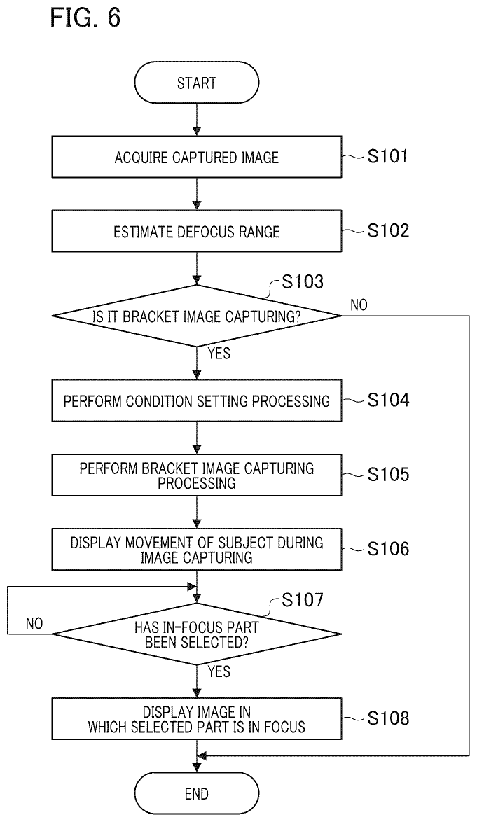

FIG. 6 is a flowchart showing an example of a flow of condition image capturing processing. The condition image capturing processing is processing in which the image capturing device 10 performs image capturing based on the image capturing conditions set on the basis of the range information. In the Embodiment, when the camera main body 1000 is powered on and the image capturing device 10 is started, the condition image capturing processing starts.

The image capturing unit 404 acquires a captured image by image capturing (Step (which may hereinafter be referred to as “S”) 101). Examples of the captured image acquired in Step 101 include a live view image. In addition, the acquired captured image is recorded in the memory 1006.

The range estimation unit 401 inputs the captured image, which has been captured by the image capturing device 10 and recorded in the memory 1006, to a defocus range estimation model recorded in the ROM 1004. Further, the range estimation unit 401 estimates the defocus range of each part of the subject appearing in the captured image by obtaining an output from the defocus range estimation model, thereby generating the range information for each part of the subject (S102).

The range estimation unit 401 transmits each piece of the range information indicating the defocus range for each part to the condition setting unit 403.

Here, the defocus range estimation model is a model obtained by machine learning. In the Embodiment, deep learning in which a feature amount for learning and a joint weighting coefficient are generated utilizing a neural network is used as a specific algorithm for machine learning.

Machine learning using a neural network will be described. Machine learning is performed using, as input data, images and learning data including correct defocus ranges and correct labels of subjects and parts.

In addition, in machine learning, error detection processing and weight updating processing are performed. In the error detection processing, an error between output data output from an output layer of the neural network in response to the input data input to an input layer, and teacher data is obtained.

In this case, information indicating the correct defocus range is used as the teacher data. In addition, in the error detection processing, an error between output data from the neural network and teacher data may be calculated using a loss function.

In the weight updating processing, on the basis of the error obtained in the error detection processing, the joint weighting coefficient and the like between nodes in the neural network are updated such that the error is reduced.

In this weight updating processing, for example, the joint weighting coefficient and the like are updated using an error back-propagation method. The error back-propagation method is a technique of adjusting the joint weighting coefficient and the like between the nodes in each neural network such that the foregoing error is reduced.

The defocus range estimation model is not limited to the foregoing example, and any machine learning model may be used. In addition, instead of the technique of using a machine learning model, the range estimation unit 401 may calculate the defocus range by a known image processing method.

The image capturing judgment unit 402 judges whether or not to perform the bracket image capturing using the image capturing device 10 on the basis of the range information generated in Step 102 (S103).

The image capturing judgment unit 402 focuses on the defocus amount of the part of the subject positioned on the closest side with respect to the image capturing device 10 and the defocus amount of the part of the subject positioned on the farthest side with respect to the image capturing device 10, among the defocus amounts identified from each piece of the generated range information.

In addition, when the position of a portion having the larger absolute value of the defocus amount of the two defocus amounts focused on is the in-focus position, the image capturing judgment unit 402 judges whether or not the position of the image capturing lens 1101 corresponding to this in-focus position is included within an in-focus range of the image capturing lens 1101.

When the position of the image capturing lens 1101 corresponding to the in-focus position is included within the in-focus range of the image capturing lens 1101, the image capturing judgment unit 402 judges that the bracket image capturing is to be performed using the image capturing device 10.

In addition, when the position of the image capturing lens 1101 corresponding to the in-focus position is not included within the in-focus range of the image capturing lens 1101, the image capturing judgment unit 402 judges that the bracket image capturing is not to be performed using the image capturing device 10.

When it is judged by the image capturing judgment unit 402 that the bracket image capturing is not to be performed using the image capturing device 10 (No in S103), the condition image capturing processing ends.

In addition, when it is judged by the image capturing judgment unit 402 that the bracket image capturing is to be performed using the image capturing device 10 (Yes in S103), the condition setting unit 403 performs condition setting processing on the basis of the range information of each part of the subject generated in Step 101 (S104).

As will be described below in detail, the condition setting processing is processing in which the condition setting unit 403 sets conditions for the bracket image capturing by the image capturing device 10. The condition setting unit 403 transmits the image capturing condition information indicating the set image capturing conditions to the image capturing unit 404.

The image capturing unit 404 performs bracket image capturing processing on the basis of the image capturing condition information generated in Step 104 (S105). As will be described below in detail, the bracket image capturing processing is processing in which the image capturing unit 404 performs the bracket image capturing on the basis of the image capturing condition information.

The system control unit 1002 causes the rear monitor 1009 to display an image showing movement of the subject when the bracket image capturing was performed (S106).

The system control unit 1002 judges whether or not a part of the subject which has been the in-focus position during the bracket image capturing in the image displayed by the rear monitor 1009 in Step 106 has been selected in the touch panel 1010 (S107). While a negative result continues (No in S107), the processing in Step 107 is repeated.

In addition, when a part of the subject which has been the in-focus position during the bracket image capturing is selected (Yes in S107), the processing proceeds to the next step. The system control unit 1002 causes the rear monitor 1009 to display the image, of the captured images generated during the bracket image capturing, in which the part selected in Step 107 is in focus (S108).

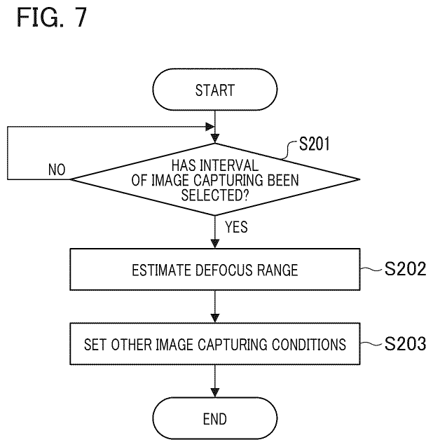

FIG. 7 is a flowchart showing an example of a flow of the condition setting processing (refer to S104 in FIG. 6). The condition setting unit 403 judges whether or not a time interval between the end of one process of image capturing and the start of next image capturing is selected during the bracket image capturing to be executed (S201).

In the Embodiment, during the bracket image capturing, image capturing is performed at time intervals selected by the user. The time interval selected in Step 201 may hereinafter be referred to as a bracket interval.

The image capturing device 10 receives selection of the bracket interval via an operation or the like of the user on the touch panel 1010. In addition, while a negative result continues in Step 201 (No in S201), the processing in Step 201 is repeated.

In addition, when the time interval during the bracket image capturing is selected (Yes in S201), the processing proceeds to the next step. The range estimation unit 401 estimates the defocus range of each part of the subject appearing in the captured image acquired in Step 101 of the condition image capturing processing (refer to FIG. 6), thereby generating the range information for each part of the subject (S202).

The processing in Step 202 is the same processing as Step 102 of the condition image capturing processing. For this reason, when a defocus range has already been estimated in the condition image capturing processing, the processing in Step 202 may be omitted in the condition setting processing.

The condition setting unit 403 sets other image capturing conditions for the bracket image capturing, except for the time interval selected in Step 201 (S203). Examples of other image capturing conditions include the drive amount and the position after driving of the image capturing lens 1101 at the bracket intervals, the number of times of image capturing, and the position of the image capturing lens 1101 when the bracket image capturing ends.

For this reason, the condition setting unit 403 can also be regarded as a calculation means for calculating the drive range of the image capturing lens 1101 for the bracket image capturing. In addition, the number of times of image capturing can also be regarded as the number of shots of captured images.

Here, the condition setting unit 403 determines the drive amount of the image capturing lens 1101 at the bracket intervals so as to focus on the target part for each subject for each process of image capturing.

In addition, when a position on the side even closer than the target part of the subject positioned on the closest side with respect to the image capturing device 10 is set as the in-focus position, the condition setting unit 403 sets the drive position of the image capturing lens 1101 corresponding to this in-focus position in the drive range of the image capturing lens 1101.

In addition, when a position on the side even farther than the target part of the subject positioned on the farthest side with respect to the image capturing device 10 is set as the in-focus position, the condition setting unit 403 sets the drive position of the image capturing lens 1101 corresponding to this in-focus position in the drive range of the image capturing lens 1101.

The drive position of the image capturing lens 1101 corresponding to the target part of the subject positioned on the closest side with respect to the image capturing device 10 may hereinafter be referred to as a corresponding position of a closer side part.

In addition, when the position on the side even closer than the target part of the subject positioned on the closest side with respect to the image capturing device 10 is set as the in-focus position, the drive position of the image capturing lens 1101 corresponding to this in-focus position may hereinafter be referred to as a margin position on the closer side.

In addition, the drive position of the image capturing lens 1101 corresponding to the target part of the subject positioned on the farthest side with respect to the image capturing device 10 may hereinafter be referred to as a corresponding position of a farther side part.

In addition, when the position on the side even farther than the target part of the subject positioned on the farthest side with respect to the image capturing device 10 is set as the in-focus position, the drive position of the image capturing lens 1101 corresponding to this in-focus position may hereinafter be referred to as a margin position on the farther side.

The condition setting unit 403 identifies the drive amount of the image capturing lens 1101 at the bracket intervals. The drive amount of the image capturing lens 1101 at the bracket intervals may hereinafter be referred to as an interval drive amount.

Further, the condition setting unit 403 sets the position on the side even closer than the position advanced by the interval drive amount from the corresponding position of the closer side part to the closer side as the margin position on the closer side. In addition, the condition setting unit 403 sets the position on the side even farther than the position advanced by the interval drive amount from the corresponding position of the farther side part to the farther side as the margin position on the farther side.

Accordingly, even when an error occurs in the estimated defocus range and driving of the image capturing lens 1101, it becomes easier to acquire an image in which the target part is in focus.

The condition setting unit 403 sets each of the image capturing conditions for the bracket image capturing on the basis of the range information.

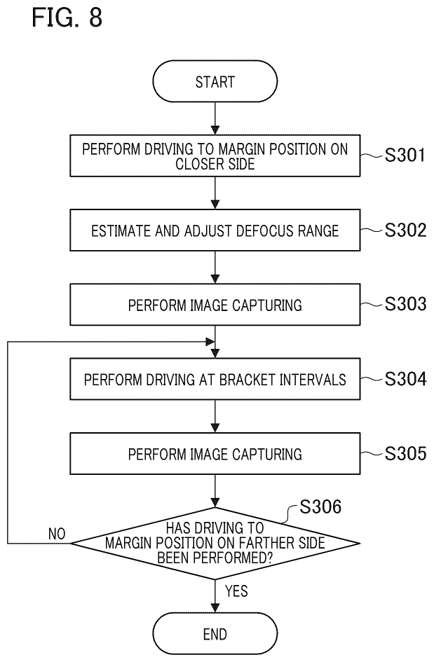

FIG. 8 is a flowchart showing an example of a flow of the bracket image capturing processing (refer to S105 in FIG. 6).

The lens control portion 1105 drives the image capturing lens 1101 to the margin position on the closer side (S301).

The range estimation unit 401 estimates the defocus range of each part of the subject. In addition, the condition setting unit 403 adjusts the range of the bracket image capturing on the basis of the estimated defocus range (S302). More specifically, the image capturing element 1001 performs image capturing and generates an image in a state in which the image capturing lens 1101 is positioned at the margin position on the closer side.

The range estimation unit 401 estimates the defocus range of each part of the subject on the basis of the generated image, thereby generating the range information for each part of the subject. Further, the condition setting unit 403 adjusts the interval drive amount and the like set as the image capturing conditions, on the basis of the latest range information.

The image capturing unit 404 performs first image capturing in the bracket image capturing (S303).

When the first image capturing ends, the lens control portion 1105 drives the image capturing lens 1101 toward the farther side with respect to the image capturing device 10 by the interval drive amount at the bracket intervals (S304). Accordingly, the in-focus position in the next image capturing is set as a position on the farther side with respect to the image capturing device 10 than in the first image capturing.

The image capturing unit 404 performs the next image capturing (S305).

The lens control portion 1105 judges whether or not the image capturing lens 1101 has been driven to the margin position on the farther side (S306).

When the image capturing lens 1101 has not been driven to the margin position on the farther side (No in S305), the processing from Step 304 is repeated. Accordingly, driving of the image capturing lens 1101 to the farther side by the interval drive amount at the bracket intervals, and image capturing are repeated until the image capturing lens 1101 is driven to the margin position on the farther side.

In addition, when the image capturing lens 1101 is driven to the margin position on the farther side (Yes in S305), the bracket image capturing processing ends.

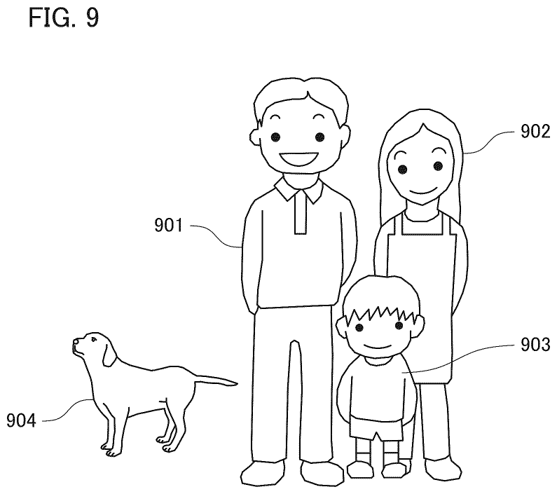

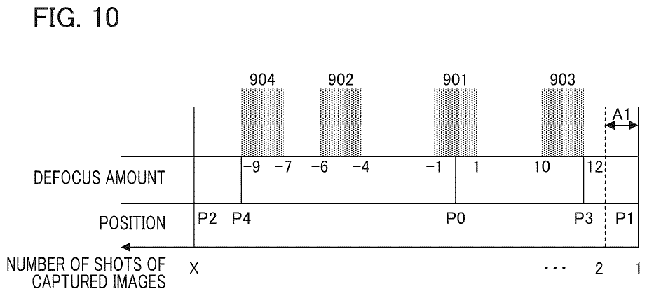

Next, a specific example of the bracket image capturing processing will be described. FIG. 9 is a view showing an example of a captured image. In addition, FIG. 10 is a diagram showing an example of a relationship between the subjects and the image capturing conditions for the bracket image capturing set by the condition setting unit 403. Hereinafter, bracket image capturing processing executed when the captured image shown in FIG. 9 is obtained will be described.

The captured image shown in FIG. 9, an adult male 901, an adult female 902, a child 903, and a dog 904. In addition, it is assumed that the captured image shown in FIG. 9 is an image captured when the face of the adult male 901 is the in-focus position, and the child 903, the adult male 901, the adult female 902, and the dog 904 are positioned in order from the closer side with respect to the image capturing device 10.

In addition, when the face of the adult male 901 is at the in-focus position, the image capturing lens 1101 is positioned at a position P0 corresponding to this in-focus position.

In this case, first, in the condition image capturing processing or the condition setting processing, the range estimation unit 401 estimates the defocus range (refer to S102 in FIGS. 6 and S202 in FIG. 7). In this example, as shown in FIG. 10, it is assumed that the defocus range of the face of the child 903 is a range of “10” to “12”.

In addition, it is assumed that the defocus range of the face of the adult male 901 is a range of “−1” to “1”. In addition, it is assumed that the defocus range of the adult female 902 is a range of “−6” to “−4”. In addition, it is assumed that the defocus range of the dog 904 is a range of “−7” to “−9”.

Next, the condition setting unit 403 sets the image capturing conditions for the bracket image capturing (refer to S203 in FIG. 7). In this example, the condition setting unit 403 sets the interval drive amount to A1. In addition, the condition setting unit 403 sets the margin position on the closer side to P1 and sets the margin position on the farther side to a position P2.

Here, both the distance from a corresponding position P3 of the closer side part to the margin position P1 on the closer side and the distance from the corresponding position P4 of the farther side part to the margin position P2 on the farther side are larger than the interval drive amount A1. In addition, the condition setting unit 403 sets the number of times of image capturing during the bracket image capturing to X times.

When the image capturing conditions are set, during the bracket image capturing processing (refer to FIG. 8), the lens control portion 1105 drives the image capturing lens 1101 from the position P0 of the image capturing lens 1101 corresponding to the face of the person 901 which has been the in-focus position to the margin position P1 on the closer side (S301).

Further, when the first image capturing in the bracket image capturing is performed (S303), the image capturing lens 1101 is driven by the interval drive amount A1 at the bracket intervals (S304), and then second image capturing is performed (S305).

In this way, image capturing is performed every time the image capturing lens 1101 is driven from the margin position P1 on the closer side to the farther side by the interval drive amount A1 at the bracket intervals.

Accordingly, image capturing having the face of the child 903 as the in-focus position, image capturing having the face of the adult male 901 as the in-focus position, image capturing having the face of the adult female 902 as the in-focus position, and image capturing having the face of the dog 904 as the in-focus position are performed. Further, when the image capturing lens 1101 is driven to the margin position P2 on the farther side (Yes in S306), the bracket image capturing processing ends.

The drive amount of the image capturing lens 1101 required during a period from when the first image capturing of the bracket image capturing is performed until the bracket image capturing processing ends is a distance from the margin position P1 on the closer side to the margin position P2 on the farther side.

Here, the lens control portion 1105 may judge that the conditions for ending the bracket image capturing processing are satisfied when the drive amount of the image capturing lens 1101 after the first image capturing in the bracket image capturing reaches the distance from the margin position P1 on the closer side to the margin position P2 on the farther side.

### Second Embodiment

Next, the image capturing device 10 of Second Embodiment will be described. In Second Embodiment, during the bracket image capturing, the image capturing lens 1101 is driven such that each part of the subject set in advance is the in-focus position.

Regarding the image capturing device 10 of Second Embodiment, configurations different from those of First Embodiment will be described, and description of the same configuration as that in First Embodiment will be omitted.

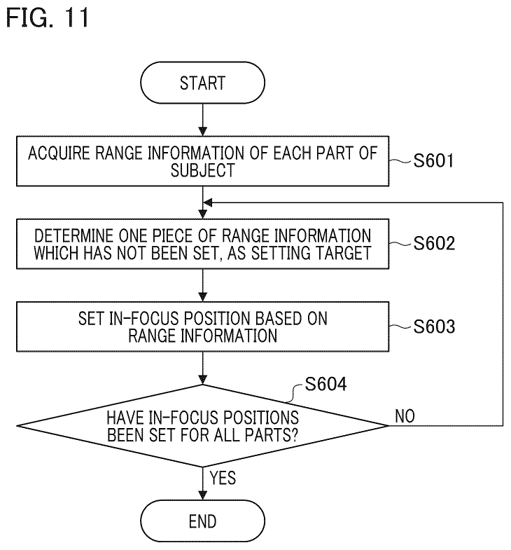

FIG. 11 is a flowchart showing another example of a flow of the condition setting processing in Second Embodiment. The condition setting unit 403 acquires the range information of each part of the subject generated by the range estimation unit 401 in Step 102 of the condition image capturing processing (refer to FIG. 6) (S601).

The condition setting unit 403 determines, as the range information of a part targeted for in-focus position setting, one piece of the range information related to the part for which the in-focus position, from the range information acquired in Step 601 (S602). The part determined in Step 602 to be targeted for in-focus position setting may hereinafter be referred to as a part targeted for setting.

The condition setting unit 403 sets the in-focus position of the part targeted for setting on the basis of the range information of the part targeted for setting (S603). More specifically, the condition setting unit 403 sets the in-focus position of the part targeted for setting to the position of a portion having a defocus amount with the minimum value and the position of a portion having a defocus amount with the maximum value identified from the range information of the part targeted for setting.

The condition setting unit 403 writes the information indicating the defocus amount at the set in-focus position in a database of defocus amounts stored in the RAM 1005.

The condition setting unit 403 judges whether or not the in-focus positions have been set for all parts for which the range information is provided (S604).

When the in-focus positions have not been set for all parts (No in S604), the processing from Step 602 is repeated. Accordingly, until the in-focus positions are set for all parts, the processing in Step 602 and Step 603 is performed for each part for which the in-focus position has not been set.

In addition, when the in-focus positions have been set for all parts (Yes in S604), the condition setting processing ends in response to transmission of the information indicating the in-focus position for each part to the image capturing unit 404 by the condition setting unit 403. The information indicating the in-focus position may hereinafter be referred to as in-focus position information.

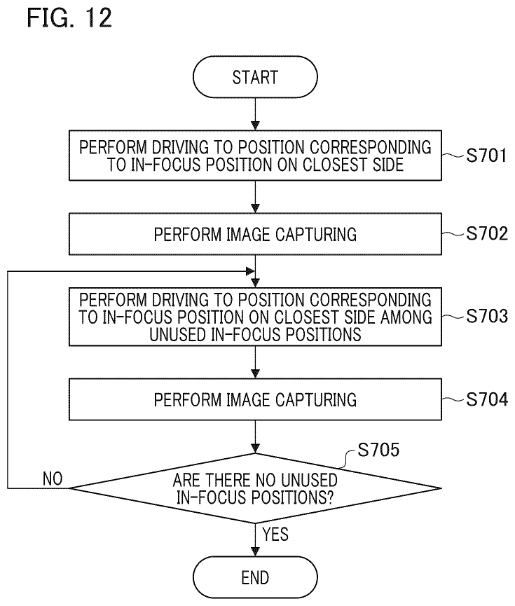

FIG. 12 is a flowchart showing another example of a flow of the bracket image capturing processing in Second Embodiment.

The lens control portion 1105 drives the image capturing lens 1101 to a position corresponding to the in-focus position on the closest side with respect to the image capturing device 10, among the in-focus positions set in the condition setting processing (S701). The image capturing unit 404 performs the first image capturing in the bracket image capturing (S702).

The lens control portion 1105 drives the image capturing lens 1101 to a position corresponding to the in-focus position on the closest side with respect to the image capturing device 10, among the in-focus positions set in the condition setting processing and the in-focus positions which have not been used during the bracket image capturing being executed (S703).

The image capturing unit 404 performs the next image capturing (S704). The lens control portion 1105 judges whether or not there are any in-focus positions which have not been used during the bracket image capturing being executed, among the in-focus positions set in the condition setting processing (S705).

When there are in-focus positions which have not been used during the bracket image capturing being executed (No in S705), the processing from Step 703 is repeated. Accordingly, until image capturing of all the in-focus positions set in the condition setting processing is performed, driving of the image capturing lens 1101 to a position corresponding to the in-focus position on the closest side with respect to the image capturing device 10 among the unused in-focus positions, and image capturing are repeated.

In addition, when there are no in-focus positions which have not been used during the bracket image capturing being executed (Yes in S705), the bracket image capturing processing ends.

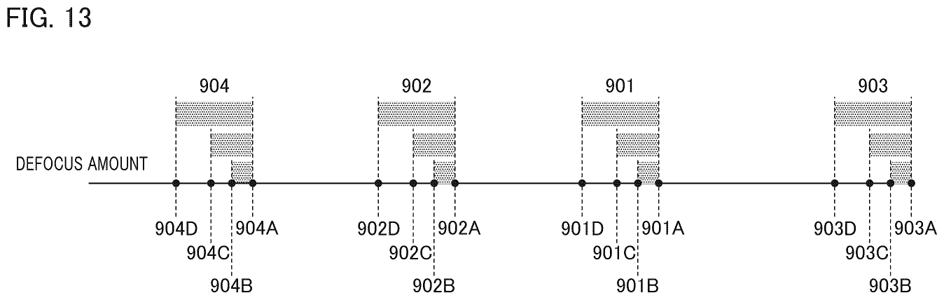

Next, a specific example of the bracket image capturing processing in the Embodiment will be described. FIG. 13 is a diagram showing another example of a relationship between the subjects and the image capturing conditions for the bracket image capturing set by the condition setting unit 403.

Hereinafter, the bracket image capturing processing executed when the captured image shown in FIG. 9 is obtained will be described. In addition, in the Embodiment, it is assumed that the target parts are the pupils, the face, and the torso of the subject.

First, in the condition image capturing processing, the range estimation unit 401 estimates the defocus range (refer to S102 in FIG. 6). As shown in FIG. 13, for the child 903, the defocus range of the pupils is estimated to be “903B” to “903A”, the defocus range of the face is estimated to be “903C” to “903A”, and the defocus range of the torso is estimated to be “903D” to “903A”.

In addition, for the adult male 901, the defocus range of the pupils is estimated to be “901B” to “901A”, the defocus range of the face is estimated to be “901C” to “901A”, and the defocus range of the torso is estimated to be “901D” to “901A”.

In addition, for the adult female 902, the defocus range of the pupils is estimated to be “902B” to “902A”, the defocus range of the face is estimated to be “902C” to “902A”, and the defocus range of the torso is estimated to be “902D” to “902A”.

In addition, for the dog 904, the defocus range of the pupils is estimated to be “904B” to “904A”, the defocus range of the face is estimated to be “904C” to “904A”, and the defocus range of the torso is estimated to be “904D” to “904A”.

Next, the condition setting unit 403 sets, as the image capturing conditions for the bracket image capturing, the in-focus position for each process of image capturing and the position of the image capturing lens 1101 corresponding to the in-focus position (S603 in FIG. 11). In this example, the condition setting unit 403 sets the in-focus position of the pupils of the child 903 to the position of a portion where the defocus amount is 903A and the position of a portion where the defocus amount is 903B.

In addition, the condition setting unit 403 sets the in-focus position of the face of the child 903 to the position of a portion where the defocus amount is 903A and the position of a portion where the defocus amount is 903C. In addition, the condition setting unit 403 sets the in-focus position of the torso of the child 903 to the position of a portion where the defocus amount is 903A and the position of a portion where the defocus amount is 903D.

In addition, the condition setting unit 403 sets the in-focus position of the pupils of the adult male 901 to the position of a portion where the defocus amount is 901A and the position of a portion where the defocus amount is 901B. In addition, the condition setting unit 403 sets the in-focus position of the face of the adult male 901 to the position of a portion where the defocus amount is 901A and the position of a portion where the defocus amount is 901C.

In addition, the condition setting unit 403 sets the in-focus position of the torso of the adult male 901 to the position of a portion where the defocus amount is 901A and the position of a portion where the defocus amount is 901D.

In addition, the condition setting unit 403 sets the in-focus position of the pupils of the adult female 902 to the position of a portion where the defocus amount is 902A and the position of a portion where the defocus amount is 902B. In addition, the condition setting unit 403 sets the in-focus position of the face of the adult female 902 to the position of a portion where the defocus amount is 902A and the position of a portion where the defocus amount is 902C.

In addition, the condition setting unit 403 sets the in-focus position of the torso of the adult female 902 to the position of a portion where the defocus amount is 902A and the position of a portion where the defocus amount is 902D.

In addition, the condition setting unit 403 sets the in-focus position of the pupils of the dog 904 to the position of a portion where the defocus amount is 904A and the position of a portion where the defocus amount is 904B. In addition, the condition setting unit 403 sets the in-focus position of the face of the dog 904 to the position of a portion where the defocus amount is 904A and the position of a portion where the defocus amount is 904C.

In addition, the condition setting unit 403 sets the in-focus position of the torso of the dog 904 to the position of a portion where the defocus amount is 904A and the position of a portion where the defocus amount is 904D. In addition, the condition setting unit 403 sets the position of the image capturing lens 1101 corresponding to each of the set in-focus positions to the position after driving of the image capturing lens 1101.

Next, during the bracket image capturing processing (refer to FIG. 12), the lens control portion 1105 drives the image capturing lens 1101 to a position corresponding to a portion where the defocus amount is 903A (S701).

Further, when the first image capturing in the bracket image capturing is performed (S702), the image capturing lens 1101 is driven to a position corresponding to a portion where the defocus amount is 903B (S703), and then the second image capturing is performed (S704).

In this way, the in-focus positions are set in order from the target part positioned on the closest side with respect to the image capturing device 10, and image capturing is performed. Accordingly, image capturing having the pupils, the face, and the torso of the child 903 as the in-focus positions, image capturing having the pupils, the face, and the torso of the adult male 901 as the in-focus positions, image capturing having the pupils, the face, and the torso of the adult female 902 as the in-focus positions, and image capturing having the pupils, the face, and the torso of the dog 904 as the in-focus positions are performed.

In addition, for each target part, image capturing of a portion having a defocus amount with the minimum value in the defocus range as the in-focus position and image capturing of a portion having a defocus amount with the maximum value in the defocus range as the in-focus position are performed.

In Second Embodiment, it has been described that a portion having a defocus amount with the minimum value and a portion having a defocus amount with the maximum value in the defocus range for a target part are set as the in-focus position, but it is not limited to this. Any position may be set as the in-focus position as long as it is a portion corresponds to the defocus range for a target part.

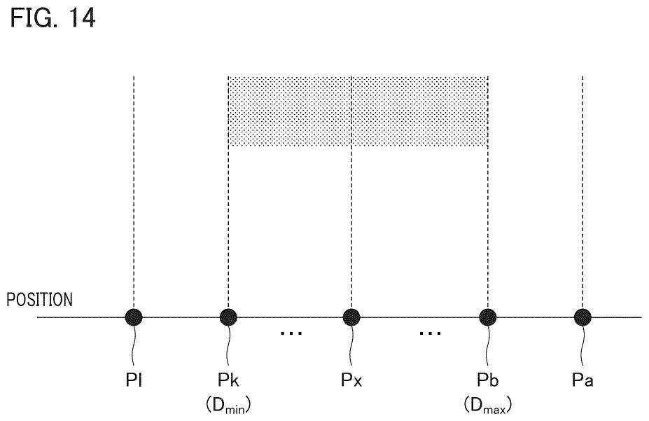

FIG. 14 is a diagram showing another example of a relationship between the subjects and the image capturing conditions for the bracket image capturing set by the condition setting unit. For example, as shown in FIG. 14, a predetermined number k of in-focus positions may be set at equal intervals in the defocus range for each target part.

In this case, when the defocus amount is D, an xth in-focus position Px in one target part is calculated from the following Equation 1.

$$Px = D min + \frac{x - 1}{k - 1} ( D max - D min ) ( x = 1 , 2 , … k ) ( k \geq 2 ) \qquad ( Equation 1 )$$

Here, a position Pb is the position of a portion having a defocus amount with the maximum value in the target parts. In addition, a position Pk is the position of a portion having a defocus amount with the minimum value in the target parts.

In this case, the position on the closest side with respect to the image capturing device 10 in the target parts is the position Pb, and the position on the farthest side with respect to the image capturing device 10 in the target parts is the position Pk. In addition, a defocus amount Dmin is the defocus amount with the minimum value in the target parts.

In addition, a defocus amount Dmax is the defocus amount with the maximum value in the target parts.

A number k of in-focus positions set for each target part may be set by the user.

In addition, a position Pa on the closer side with respect to the image capturing device 10 than the position Pb and a position P1 on the farther side with respect to the image capturing device 10 than the position Pk may be set as the in-focus positions. That is, a position different from the target part may be set as the in-focus position.

In this case, the interval between the position Pb and the position Pa, and the interval between the position Pk and the position P1 may be set by the user to any interval as long as it is within a range allowable by the configuration of the lens unit 1100.

### Modification Example 1

Next, Modification Example 1 of Second Embodiment will be described. In the Embodiment, it has been described that all target parts are set as the in-focus positions, but it is not limited to this. For example, in the target parts, only the part selected by the user may be set as the in-focus position. The part selected by the user as a target set as the in-focus position may hereinafter be referred to as a selected part.

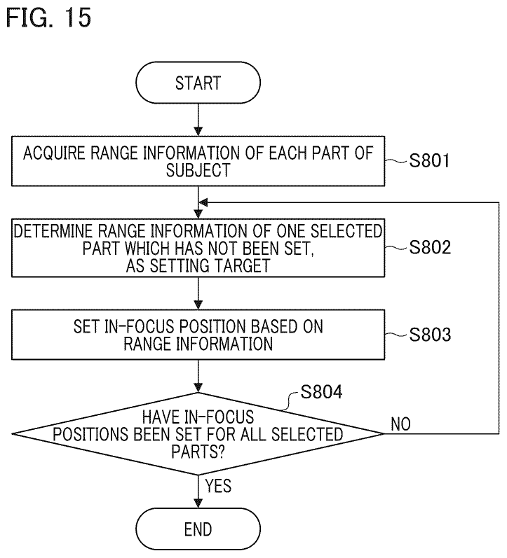

FIG. 15 is a flowchart showing another example of a flow of the condition setting processing in Modification Example 1.

The condition setting unit 403 acquires the range information of each part of the subject generated by the range estimation unit 401 in Step 102 of the condition image capturing processing (refer to FIG. 6) (S801). The processing in Step 801 is the same processing as the processing in Step 601 in the condition setting processing shown in FIG. 11.

The condition setting unit 403 determines, as the range information of a part targeted for in-focus position setting, the range information related to one selected part for which the in-focus position has not been set, from the range information acquired in Step 801 (S802).

The condition setting unit 403 sets the in-focus position of the part targeted for setting on the basis of the range information of the part targeted for setting (S803). The processing in Step 803 is the same processing as the processing in Step 603 in the condition setting processing shown in FIG. 11.

The condition setting unit 403 judges whether or not the in-focus positions have been set for all selected parts for which the range information is provided (S804).

When the in-focus positions have not been set for all selected parts (No in S804), the processing from Step 802 is repeated. Accordingly, until the in-focus positions are set for all selected parts, the processing in Step 802 and Step 803 is performed for each selected part for which the in-focus position has not been set.

In addition, when the in-focus positions have been set for all selected parts (Yes in S804), the condition setting processing ends in response to transmission of the in-focus position information indicating the in-focus position for each selected part to the image capturing unit 404 by the condition setting unit 403.

A specific example of Modification Example 1 will be described. It is assumed that the captured image shown in FIG. 9 is acquired when the selected part is only the face of a subject. In this case, the condition setting unit 403 sets the in-focus position of the face of the child 903 to the position of a portion where the defocus amount is 903A (refer to FIG. 13) and the position of a portion where the defocus amount is 903C.

In addition, the condition setting unit 403 sets the in-focus position of the face of the adult male 901 to the position of a portion where the defocus amount is 901A and the position of a portion where the defocus amount is 901C. In addition, the condition setting unit 403 sets the in-focus position of the face of the adult female 902 to the position of a portion where the defocus amount is 902A and the position of a portion where the defocus amount is 902C.

In addition, the condition setting unit 403 sets the in-focus position of the face of the dog 904 to the position of a portion where the defocus amount is 904A and the position of a portion where the defocus amount is 904C.

The part to be targeted for the in-focus position is not limited to the part selected by the user. For example, the part to be targeted for the in-focus position may be set in advance for each type of the subject. As an example, when the subject is a human, the pupils and the torso may be set as the in-focus positions, and when the subject is an animal other than a human, only the torso may be set as the in-focus position.

In addition, the part to be targeted for the in-focus position may be set in accordance with the image capturing mode of the image capturing device 10. As an example, when the image capturing mode of the image capturing device 10 is portrait mode, the face of a living being (subject) may be set as the in-focus position, and when the image capturing mode of the image capturing device 10 is sports mode, the torso of a living being (subject) may be set as the in-focus position.

In this case, the image capturing mode may be set by the user or may be set in accordance with the situation of the subject included in the angle of view. In addition, the information indicating the part to be targeted for the in-focus position may be stored in the ROM 1004 of the image capturing device 10.

### Modification Example 2

Next, Modification Example 2 of Second Embodiment will be described. In Modification Example 2, only the part of the subject selected by the user among the subjects appearing in a captured image may be set as the in-focus position. The subject selected by the user as a target set as the in-focus position may hereinafter be referred to as a selected subject.

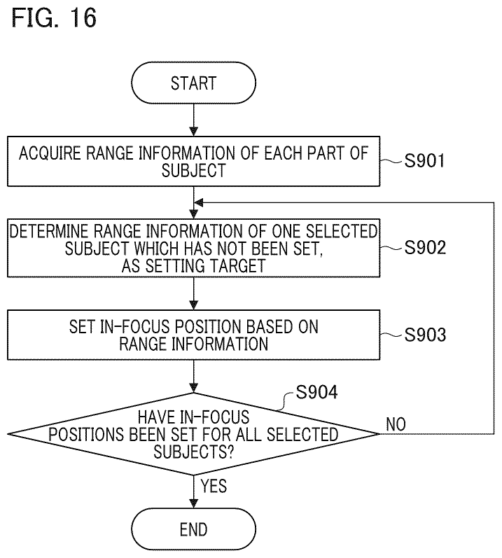

FIG. 16 is a flowchart showing another example of a flow of the condition setting processing in Modification Example 2.

The condition setting unit 403 acquires the range information of each part of the subject generated by the range estimation unit 401 in Step 102 of the condition image capturing processing (refer to FIG. 6) (S901). The processing in Step 901 is the same processing as the processing in Step 601 in the condition setting processing shown in FIG. 11.

The condition setting unit 403 determines, as the range information of a part targeted for in-focus position setting, the range information related to a part of one selected subject for which the in-focus position has not been set, from the range information acquired in Step 901 (S902).

The condition setting unit 403 sets the in-focus position of the part targeted for setting on the basis of the range information of the part targeted for setting (S903). The processing in Step 903 is the same processing as the processing in Step 603 in the condition setting processing shown in FIG. 11.

The condition setting unit 403 judges whether or not the in-focus positions have been set for all parts of the selected subjects for which the range information is provided (S904).

When the in-focus positions have not been set for all parts of the selected subjects (No in S904), the processing from Step 902 is repeated. Accordingly, until the in-focus positions are set for all parts of the selected subjects, the processing in Step 902 and Step 903 is performed for each part of the selected subject for which the in-focus position has not been set.

In addition, when the in-focus positions have been set for all parts of the selected subjects (Yes in S904), the condition setting processing ends in response to transmission of the in-focus position information indicating the in-focus position for each part of the selected subject to the image capturing unit 404 by the condition setting unit 403.

A specific example of Modification Example 2 will be described. It is assumed that the captured image shown in FIG. 9 is acquired when the selected subject is only a human.

In this case, the condition setting unit 403 sets the in-focus position of the pupils of the child 903 to the position of a portion where the defocus amount is 903A (refer to FIG. 13) and the position of a portion where the defocus amount is 903B.

In addition, the condition setting unit 403 sets the in-focus position of the face of the child 903 to the position of a portion where the defocus amount is 903A and the position of a portion where the defocus amount is 903C. In addition, the condition setting unit 403 sets the in-focus position of the torso of the child 903 to the position of a portion where the defocus amount is 903A and the position of a portion where the defocus amount is 903D.

In addition, the condition setting unit 403 sets the in-focus position of the pupils of the adult male 901 to the position of a portion where the defocus amount is 901A and the position of a portion where the defocus amount is 901B. In addition, the condition setting unit 403 sets the in-focus position of the face of the adult male 901 to the position of a portion where the defocus amount is 901A and the position of a portion where the defocus amount is 901C.

In addition, the condition setting unit 403 sets the in-focus position of the torso of the adult male 901 to the position of a portion where the defocus amount is 901A and the position of a portion where the defocus amount is 901D.

In addition, the condition setting unit 403 sets the in-focus position of the pupils of the adult female 902 to the position of a portion where the defocus amount is 902A and the position of a portion where the defocus amount is 902B. In addition, the condition setting unit 403 sets the in-focus position of the face of the adult female 902 to the position of a portion where the defocus amount is 902A and the position of a portion where the defocus amount is 902C.

In addition, the condition setting unit 403 sets the in-focus position of the torso of the adult female 902 to the position of a portion where the defocus amount is 902A and the position of a portion where the defocus amount is 902D. In addition, no in-focus position is set for the dog 904.

The subject to be targeted for the in-focus position is not limited to the subject selected by the user. For example, the subject to be targeted for the in-focus position may be set in advance. As an example, a human may be set as the subject to be targeted for the in-focus position, and a living being different from a human may not be set as the target for the in-focus position.

In addition, the subject to be targeted for the in-focus position may be set in accordance with the image capturing mode of the image capturing device 10. As an example, when the image capturing mode of the image capturing device 10 is the portrait mode or the sports mode, a human may be set as the target for the in-focus position, when the image capturing mode of the image capturing device 10 is a dog mode, the dog may be set as the target for the in-focus position.

In this case, the image capturing mode may be set by the user or may be set in accordance with the situation of the subject included in the angle of view. In addition, the information indicating the subject to be targeted for the in-focus position may be stored in the ROM 1004 of the image capturing device 10.

In addition, Modification Example 1 and Modification Example 2 of Second Embodiment may be combined. That is, the subject to be targeted for the in-focus position and the part of the subject to be targeted for the in-focus position may be set by the user or may be set in advance.

### Modification Example 3

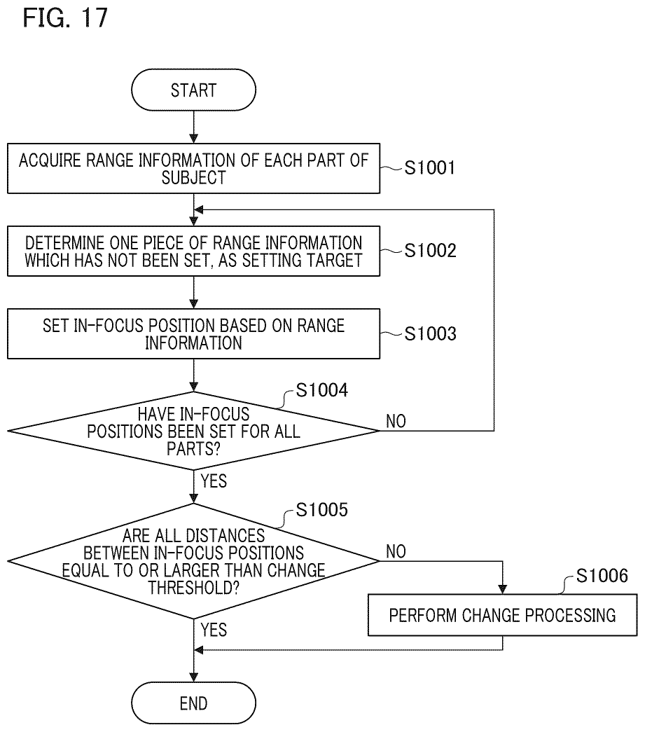

Next, Modification Example 3 of Second Embodiment will be described. FIG. 17 is a flowchart showing another example of a flow of the condition setting processing in Modification Example 3.

The processing in Step 1001 to Step 1004 of the condition setting processing shown in FIG. 17 is the same processing as the processing in Step 601 to Step 604 in the condition setting processing shown in FIG. 11. However, the in-focus position may be set by any of the techniques described above.

When the in-focus positions of all parts are set (Yes in S604), the condition setting unit 403 judges whether or not the distances between all the in-focus positions are equal to or larger than a change threshold (S1005). The distance between the in-focus positions is a distance between adjacent in-focus positions of the set in-focus positions.

In addition, the change threshold is a threshold used by the condition setting unit 403 for judging whether or not to change the set in-focus position. In addition, in the Embodiment, the distance between the in-focus positions corresponding to the shortest distance over which the image capturing lens 1101 can be driven on the basis of configuration limitations of the image capturing lens 1101 is set as the change threshold.

When the distances between all the in-focus positions are equal to or larger than the change threshold (Yes in S1005), the condition setting processing ends without changing the in-focus positions. In addition, when there are two in-focus positions whose interval is smaller than the change threshold (No in S1005), change processing is performed (S1006).

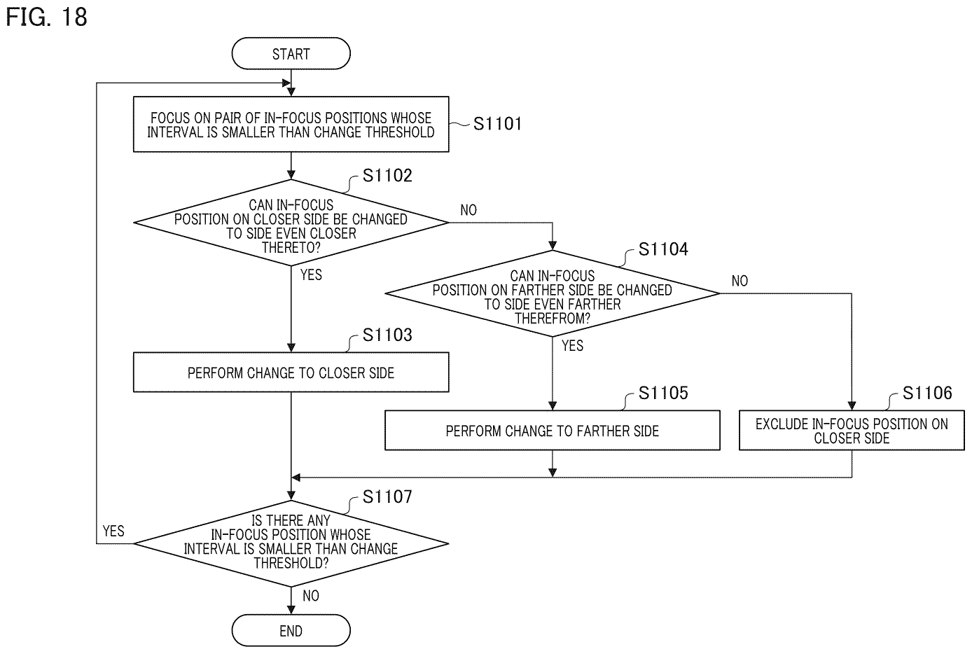

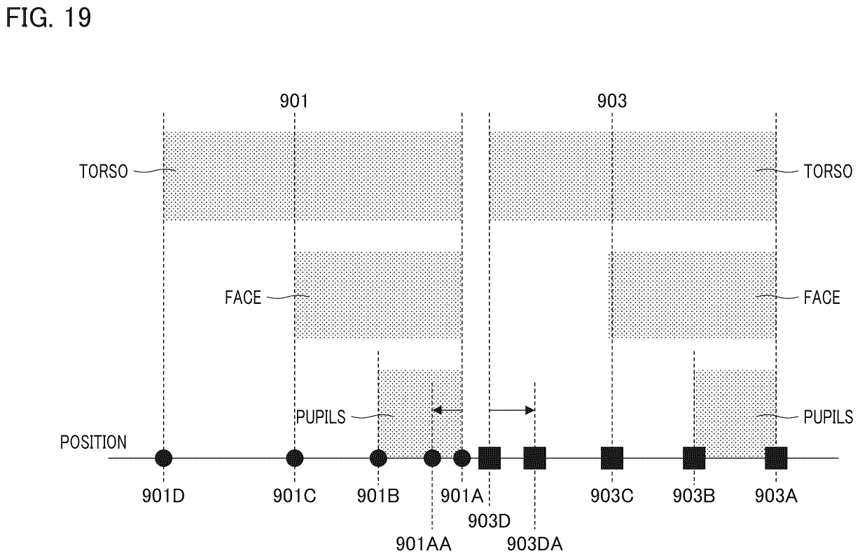

FIG. 18 is a flowchart showing an example of a flow of the change processing (refer to S1006 in FIG. 17). The change processing is processing in which the condition setting unit 403 changes the in-focus position. In addition, FIG. 19 is a diagram showing an example of a relationship between an in-focus position set for the adult male 901 and an in-focus position set for the child 903 in the captured image shown in FIG. 9. Hereinafter, in the example shown in FIG. 19, it is assumed that the change processing is performed.

In the example shown in FIG. 19, for the child 903, the position 903A, the position 903B, the position 903C, and the position 903D are set as the in-focus positions. Here, the position 903A is the position of a portion having a defocus amount with the maximum value in the pupils.

In addition, the position 903A is the position of a portion having a defocus amount with the maximum value in the face. In addition, the position 903A is the position of a portion having a defocus amount with the maximum value in the torso. In addition, the position 903B is the position of a portion having a defocus amount with the minimum value in the pupils.

In addition, the position 903C is the position of a portion having a defocus amount with the minimum value in the face. In addition, the position 903D is the position of a portion having a defocus amount with the minimum value in the torso.

In addition, in the example shown in FIG. 19, for the adult male 901, the position 901A, the position 901B, the position 901C, and the position 901D are set as the in-focus positions. Here, the position 901A is the position of a portion having a defocus amount with the maximum value in the pupils.

In addition, the position 901A is the position of a portion having a defocus amount with the maximum value in the face. In addition, the position 901A is the position of a portion having a defocus amount with the maximum value in the torso. In addition, the position 901B is the position of a portion having a defocus amount with the minimum value in the pupils.

In addition, the position 901C is the position of a portion having a defocus amount with the minimum value in the face. In addition, the position 901D is the position of a portion having a defocus amount with the minimum value in the torso. In addition, in the example shown in FIG. 19, it is assumed that the interval between the position 903D and the position 901A is smaller than the change threshold.

In the change processing (refer to FIG. 18), the condition setting unit 403 focuses on a pair of in-focus positions whose interval is smaller than the change threshold (S1101). In the example shown in FIG. 19, the condition setting unit 403 focuses on the pair of in-focus positions constituted of the position 903D and the position 901A.

The condition setting unit 403 judges whether or not the in-focus position, of the pair of in-focus positions focused on, positioned on the closer side with respect to the image capturing device 10 can be changed to a position on the side even closer to the image capturing device 10 (S1102).

More specifically, a case in which the condition setting unit 403 changes the in-focus position, of this pair of in-focus positions, on the closer side with respect to the image capturing device 10 to the position on the side even closer thereto such that the interval between the pair of in-focus positions focused on becomes equal to or larger than the change threshold is considered.

Further, in this case, judgment in Step 1102 is performed depending on whether or not a pair of in-focus positions whose interval is smaller than the change threshold are newly generated. In the example shown in FIG. 19, a case in which the condition setting unit 403 changes the position 903D to a position 903DA on the side even closer to the image capturing device 10 such that the interval between the position 901A and the position 903D becomes equal to or larger than the change threshold is considered.

Further, in this case, when the interval between the position 903DA and the position 903C is equal to or larger than the change threshold, a positive result is acquired in Step 1102, and when the interval between the position 903DA and the position 903C is smaller than the change threshold, a negative result is acquired in Step 1102.

When the in-focus position on the closer side with respect to the image capturing device 10 can be changed to a position on the side even closer thereto (Yes in S1102), the condition setting unit 403 changes the in-focus position on the closer side with respect to the image capturing device 10 to the position on the side even closer thereto (S1103).

In addition, when the in-focus position on the closer side with respect to the image capturing device 10 cannot be changed to the position on the side even closer thereto (No in S1102), the processing proceeds to the next step. The condition setting unit 403 judges whether or not the in-focus position, of the pair of in-focus positions focused on, positioned on the farther side with respect to the image capturing device 10 can be changed to a position on the side even farther from the image capturing device 10 (S1104).

More specifically, a case in which the condition setting unit 403 changes the in-focus position, of this pair of in-focus positions, on the farther side with respect to the image capturing device 10 to the position on the side even farther therefrom such that the interval between the pair of in-focus positions focused on becomes equal to or larger than the change threshold is considered.

Further, in this case, judgment in Step 1104 is performed depending on whether or not a pair of in-focus positions whose interval is smaller than the change threshold are newly generated. In the example shown in FIG. 19, a case in which the condition setting unit 403 changes the position 901A to a position 901AA on the side even farther from the image capturing device 10 such that the interval between the position 901A and the position 903D becomes equal to or larger than the change threshold is considered.

Further, in this case, when the interval between the position 901AA and the position 901B is equal to or larger than the change threshold, a positive result is acquired in Step 1104, and when the interval between the position 901AA and the position 901B is smaller than the change threshold, a negative result is acquired in Step 1104.

When the in-focus position on the farther side with respect to the image capturing device 10 can be changed to a position on the side even farther therefrom (Yes in S1104), the condition setting unit 403 changes the in-focus position on the farther side with respect to the image capturing device 10 to the position on the side even farther therefrom (S1105).

In addition, when the in-focus position on the farther side with respect to the image capturing device 10 cannot be changed to the position on the side even farther therefrom (No in S1104), the processing proceeds to the next step. The condition setting unit 403 excludes the in-focus position, of the pair of in-focus positions focused on, positioned on the closer side with respect to the image capturing device 10 from the target for the in-focus position to be set during the bracket image capturing (S1106).

In the example shown in FIG. 19, the condition setting unit 403 excludes the position 903D from the target for the in-focus position to be set during the bracket image capturing.

After Step 1103, Step 1105, or Step 1106, the processing proceeds to the next step. The condition setting unit 403 judges whether or not there are two in-focus positions whose interval is smaller than the change threshold (S1107).

When there are two in-focus positions whose interval is smaller than the change threshold (Yes in S1107), the processing from Step 1101 is repeated. In this way, until there are no longer two in-focus positions whose interval is smaller than the change threshold, the processing in Step 1101 to Step 1106 is repeated.

In addition, when there are no two in-focus positions whose interval is smaller than the change threshold (No in S1107), the change processing ends.

In the example described above, it has been described that the change processing is performed for all pairs of in-focus positions whose interval is smaller than the change threshold, but it is not limited to this.

For example, a subject for which the set in-focus positions take priority and a subject for which they do not take priority may be set. Further, when the interval between the in-focus position for the priority subject and the in-focus position for the non-priority subject is smaller than the change threshold, the in-focus position may be changed or excluded for the non-priority subject in the change processing.

In addition, the order of priority may be set for all the in-focus positions, and the target in-focus position to be changed or excluded may be determined in the change processing on the basis of the order of priority.

In addition, the presence or absence of the priority of the in-focus positions and the order of priority of the in-focus positions may be set in advance by the image capturing device 10, may be set by the user, or may be determined in accordance with the image capturing mode of the image capturing device 10.

In this way, even when there are restrictions on driving of the image capturing lens 1101 due to the configuration limitations of the image capturing lens 1101 because the change processing is performed, an image in which a part desired by the user is in focus is acquired.

Next, an example, described in Second Embodiment, in which a target set as the in-focus position is selected by the user will be described.

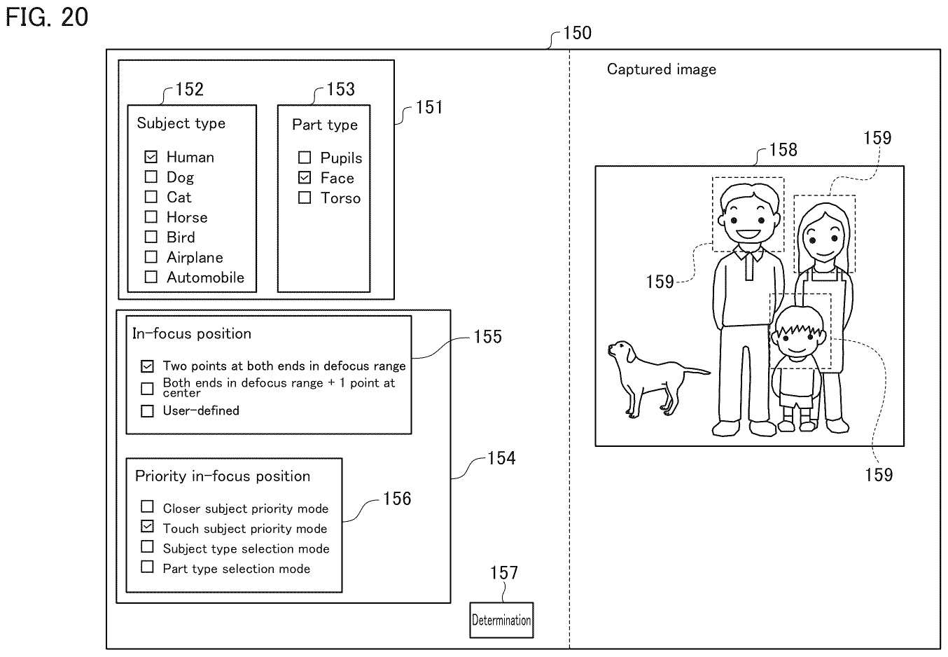

FIG. 20 is a diagram showing an example of a setting screen 150. The setting screen 150 is a screen for receiving user's selection of the target to be set as the in-focus position. For example, the system control unit 1002 of the image capturing device 10 causes the rear monitor 1009 of the image capturing device 10 to display the setting screen 150.

The setting screen 150 shows a target setting image 151, a position setting image 154, a determination portion 157, and a captured image 158.

The target setting image 151 receives user's selection of the target to be set as the in-focus position. The target setting image 151 shows a subject setting portion 152 and a part setting portion 153.

The subject setting portion 152 receives user's selection of the type of target subject to be set as the in-focus position. In the shown example, in the subject setting portion 152, a human has been selected for the type of target subject to be set as the in-focus position.

The part setting portion 153 receives user's selection of the type of the part of the target subject to be set as the in-focus position. In the shown example, in the part setting portion 153, the face has been selected as the type of the part of the target subject to be set as the in-focus position.

The position setting image 154 is an image for receiving user's setting of a method for determining the in-focus position. The position setting image 154 shows a position setting portion 155 and a mode setting portion 156.

The position setting portion 155 receives user's setting of the method for determining the in-focus position. In the shown example, in the position setting image 154, it is selected that the position of a portion having a defocus amount with the maximum value and the position of a portion having a defocus amount with the minimum value in the target parts are set as the in-focus positions.

The mode setting portion 156 receives user's setting of the mode corresponding to the in-focus position. When the determination portion 157 is selected, the details selected in the target setting image 151 and the position setting image 154 are set as the image capturing conditions for the bracket image capturing.

The captured image 158 shows the captured image acquired in Step 101 of the condition image capturing processing (refer to FIG. 6). In the shown example, the captured image shown in FIG. 9 is shown as the captured image 158.

In addition, the captured image 158 displays a high-contrast image 159. The high-contrast image 159 is an image having a high contrast for a part of the subject set as the in-focus position. In the shown example, the face of the adult male 901 (refer to FIG. 9), in each of the face of the adult female 902, and the face of the child 903, a dashed-line frame is displayed as the high-contrast image 159. Accordingly, the user recognizes that the face of a human is set as the in-focus position.

In this way, since the target for the in-focus position is set by the user via the setting screen 150, it becomes easier for the user to set the target for the in-focus position. In addition, it is easier for the user to recognize the results of user's setting for the target for the in-focus position.

In the example shown in FIG. 20, it has been described that the target setting image 151, the position setting image 154, and the captured image 158 are displayed on one screen, but it is not limited to this. The target setting image 151, the position setting image 154, and the captured image 158 may be displayed on different screens, respectively.

In addition, the target setting image 151, the position setting image 154, and the captured image 158 may be displayed by not only the image capturing device 10 but also a computer device such as a PC or smartphone used by the user.

### Modification Example 4

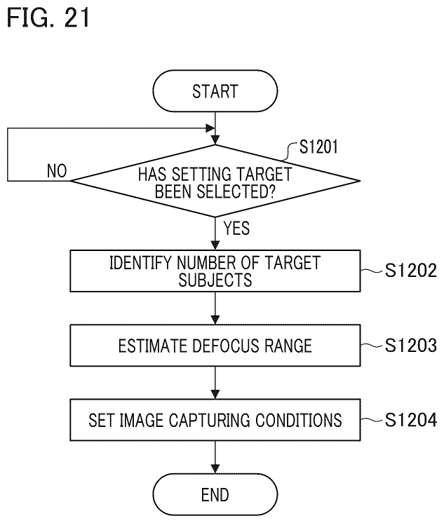

Next, Modification Example 4 of Second Embodiment will be described. FIG. 21 is a flowchart showing another example of a flow of the condition setting processing in Modification Example 4.

The condition setting unit 403 judges whether or not the subject targeted for in-focus position setting and the part of the subject targeted for in-focus position setting have been selected (S1201). The subject targeted for in-focus position setting and the part of the subject targeted for in-focus position setting may be set by any of the techniques described above.

In addition, while a negative result continues (No in S1201), the processing in Step 1201 is repeated.

In addition, when the target for the in-focus position setting is selected (Yes in S1201), the condition setting unit 403 identifies the number of subjects targeted for in-focus position setting from the captured image acquired in Step 101 of the condition image capturing processing (refer to FIG. 6) (S1202).

The range estimation unit 401 estimates the defocus range for the part selected as the target for the in-focus position setting in the subject selected as the target for the in-focus position setting from the captured image, thereby generating the range information for each part of the subject (S1203).

The condition setting unit 403 sets the image capturing conditions for the bracket image capturing on the basis of the defocus range estimated in Step 1203 (S1204).

Examples of the image capturing conditions include the in-focus position, the bracket intervals, the drive amount and the position after driving of the image capturing lens 1101 at the bracket intervals, the number of times of image capturing, and the position of the image capturing lens 1101 when the bracket image capturing ends. In addition, the position of the part selected in Step 1201 is set as the in-focus position.

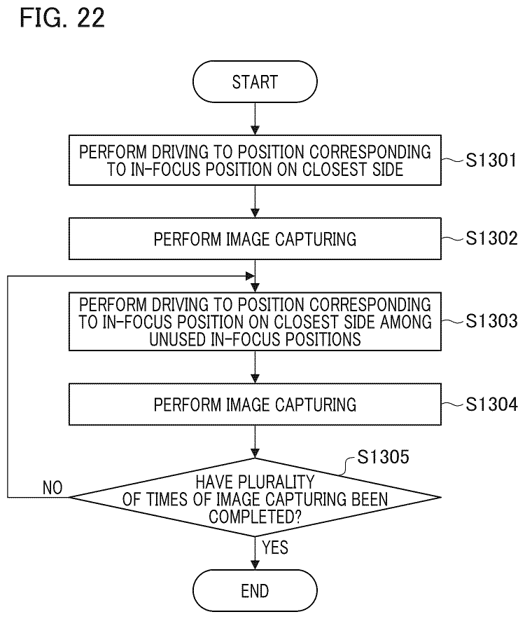

FIG. 22 is a flowchart showing another example of a flow of the bracket image capturing processing in Modification Example 4.

The lens control portion 1105 drives the image capturing lens 1101 to a position corresponding to the in-focus position on the closest side with respect to the image capturing device 10, among the in-focus positions set in the condition setting processing (S1301). The image capturing unit 404 performs the first image capturing in the bracket image capturing (S1302).

The lens control portion 1105 drives the image capturing lens 1101 to a position corresponding to the in-focus position on the closest side with respect to the image capturing device 10, among the in-focus positions set in the condition setting processing and the in-focus positions which have not been used during the bracket image capturing being executed (S1303).

The image capturing unit 404 performs the next image capturing (S1304).

The lens control portion 1105 judges whether or not image capturing of the number of subjects identified in Step 1202 of the condition setting processing (refer to FIG. 21) has been completed (S1305).

When image capturing of the identified number of subjects has not been completed (No in S1305), the processing from Step 1303 is repeated. Accordingly, until image capturing of the number of subjects identified in the condition setting processing is completed, driving of the image capturing lens 1101 to a position corresponding to the in-focus position on the closest side with respect to the image capturing device 10, and image capturing are repeated.

In addition, when image capturing of the identified number of subjects has not been completed (Yes in S1305), the bracket image capturing processing ends.

Next, a specific example of the bracket image capturing processing in Modification Example 4 will be described. Hereinafter, the bracket image capturing processing executed when the captured image shown in FIG. 9 is obtained will be described. In addition, hereinafter, it is assumed that the subject targeted for in-focus position setting is set to a human and the part of the subject targeted for in-focus position setting is set to the pupils in the condition setting processing.

In this case, during the bracket image capturing processing (refer to FIG. 22), the lens control portion 1105 drives the image capturing lens 1101 to a position corresponding to a portion of the pupils of the child 903 (S1301).

Further, the first image capturing in the bracket image capturing is performed in a state in which the in-focus position is set to the portion of the pupils of the child 903 (S1302). Next, the image capturing lens 1101 is driven to a position corresponding to a portion of the pupils of the adult male 901 (S1303), and then the second image capturing is performed in a state in which the in-focus position is set to the portion of the pupils of the adult male 901 (S1304).

In this way, the in-focus positions are set in order from a part of the subject positioned on the closest side with respect to the image capturing device 10 in the subject targeted for in-focus position setting, and image capturing is performed. Accordingly, image capturing having the pupils of the child 903, the pupils of the adult male 901, and the pupils of the adult female 902 as the in-focus positions is performed. On the other hand, image capturing having the dog 904 as the in-focus position is not performed.

### Third Embodiment

Next, the image capturing device 10 of Third Embodiment will be described. In Third Embodiment, during the bracket image capturing, the image capturing lens 1101 is driven such that image capturing is performed in a state in which the number of subjects set in advance are at the in-focus position.

Regarding the image capturing device 10 of Third Embodiment, configurations different from those of First Embodiment and Second Embodiment will be described, and description of the same configuration as that in First Embodiment or Second Embodiment will be omitted.

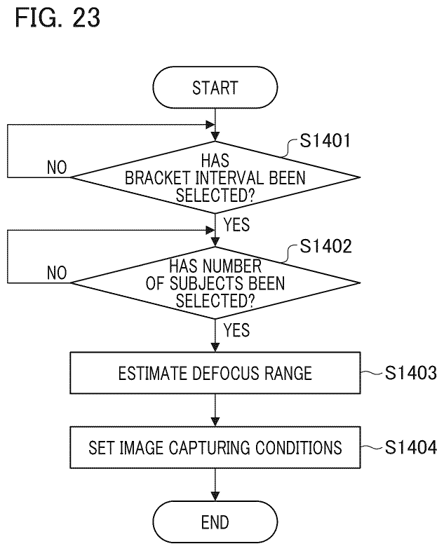

FIG. 23 is a flowchart showing another example of a flow of the condition setting processing in Third Embodiment. The condition setting unit 403 judges whether or not a bracket interval has been selected by the user (S1401). While a negative result continues (No in S1401), the processing in Step 1401 is repeated.

In addition, when the bracket interval is selected (Yes in S1401), the condition setting unit 403 judges whether or not the number of subjects targeted for in-focus position setting have been selected by the user (S1402).

In the Embodiment, during the bracket image capturing, image capturing is performed in a state in which the number of subjects selected by the user are set as the in-focus position. In addition, while a negative result continues in Step 1402 (No in S1402), the processing in Step 1402 is repeated.

In addition, when the number of subjects targeted for in-focus position setting are selected (Yes in S1402), the processing proceeds to the next step. The range estimation unit 401 estimates the defocus range of each part of the subject appearing in the captured image acquired in Step 101 of the condition image capturing processing (refer to FIG. 6), thereby generating the range information for each part of the subject (S1403).

The condition setting unit 403 sets the image capturing conditions for the bracket image capturing on the basis of the estimated defocus range (S1404). Examples of the image capturing conditions include the in-focus position, the interval drive amount, the position after driving of the image capturing lens 1101, the margin position on the closer side, the margin position on the farther side, the number of times of image capturing, and the position of the image capturing lens 1101 when the bracket image capturing ends.

In the Embodiment, the in-focus position is set for the number of subjects selected in Step 1402. In addition, the in-focus position set for the number of subjects selected in Step 1402 may hereinafter be referred to as a setting position.

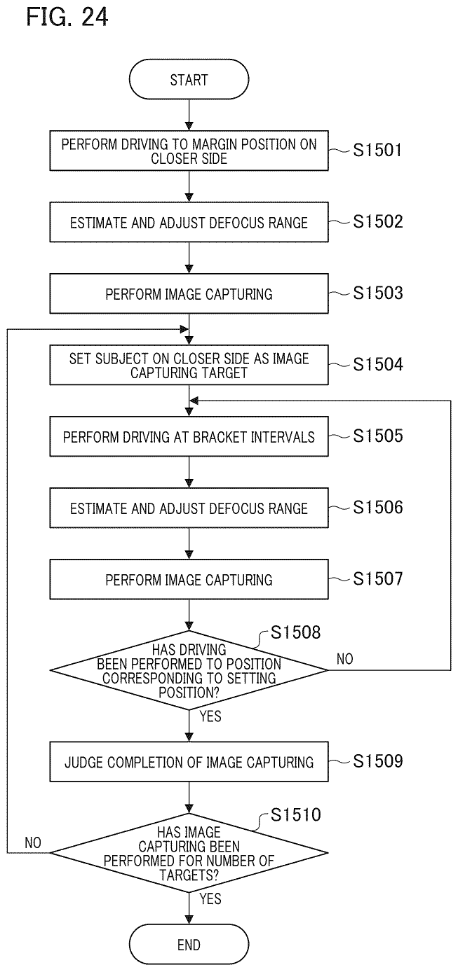

FIG. 24 is a flowchart showing another example of a flow of the bracket image capturing processing in Third Embodiment (refer to S105 in FIG. 6).

The lens control portion 1105 drives the image capturing lens 1101 to the margin position on the closer side (S1501).

The range estimation unit 401 estimates the defocus range of each part of the subject. In addition, the condition setting unit 403 adjusts the range of the bracket image capturing on the basis of the estimated defocus range (S1502). The processing in Step 1502 is the same processing as the processing in Step 302 in the bracket image capturing processing shown in FIG. 8.

The image capturing unit 404 performs the first image capturing in the bracket image capturing (S1503). When the first image capturing ends, the lens control portion 1105 sets, as a new image capturing target, the subject positioned on the closest side among the subjects for which the in-focus position is set and the subjects which are not set as the image capturing target (S1504).

The lens control portion 1105 drives the image capturing lens 1101 toward the farther side by the interval drive amount at the bracket intervals (S1505).

The range estimation unit 401 estimates the defocus range of each part of the subject. In addition, the condition setting unit 403 adjusts the range of the bracket image capturing on the basis of the estimated defocus range (S1506). The processing in Step 1506 is the same processing as the processing in Step 1502. The image capturing unit 404 performs the next image capturing (S1507).

The lens control portion 1105 judges whether or not the image capturing lens 1101 has been driven to a position corresponding to the setting position for the image capturing target subject (S1508).

When the image capturing lens 1101 has not been driven to the position corresponding to the setting position (No in S1508), the processing from Step 1505 is repeated.

Accordingly, until the image capturing lens 1101 reaches the position corresponding to the setting position for the image capturing target subject, driving of the image capturing lens 1101 to the farther side by the interval drive amount at the bracket intervals, and image capturing are repeated.

In addition, when the image capturing lens 1101 has been driven to the position corresponding to the setting position (Yes in S1508), the lens control portion 1105 judges that image capturing of the image capturing target subject has been completed (S1509).

The lens control portion 1105 judges whether or not image capturing of the number of subjects selected in Step 1402 of the condition setting processing (refer to FIG. 23) has been completed (S1510).

When image capturing of the number of selected subjects is not completed (No in S1510), the processing from Step 1504 is repeated. Accordingly, until image capturing of the number of selected subjects is completed, image capturing is performed in order from the subject positioned on the closer side with respect to the image capturing device 10.

In addition, when image capturing of the number of selected subjects is completed (Yes in S1510), the bracket image capturing processing ends.

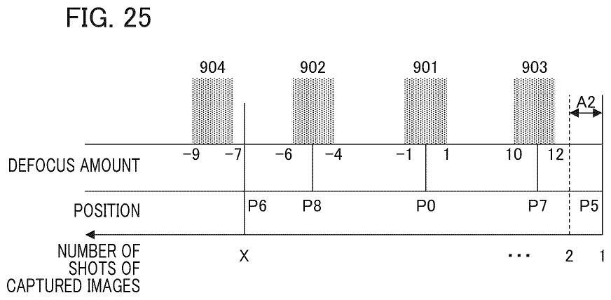

Next, a specific example of the bracket image capturing processing will be described. FIG. 25 is a diagram showing another example of a relationship between the subjects and the image capturing conditions for the bracket image capturing set by the condition setting unit 403. Hereinafter, the bracket image capturing processing executed when the captured image shown in FIG. 9 is obtained will be described.

In addition, hereinafter, it is assumed that the number selected by the user for the subjects targeted for in-focus position setting is “3” in the condition setting processing. In addition, it is assumed that the defocus range estimated before the bracket image capturing processing starts is the same range as that in the example shown in FIG. 10.

That is, before the bracket image capturing processing starts, the face of the adult male 901 is at the in-focus position. At this time, the image capturing lens 1101 is positioned at the position P0.

The condition setting unit 403 sets the image capturing conditions for the bracket image capturing in the condition setting processing (refer to S1404 in FIG. 23). In this example, the condition setting unit 403 sets the interval drive amount to A2. In addition, the condition setting unit 403 sets the margin position on the closer side to P5 and sets the margin position on the farther side to a position P6.

In addition, the condition setting unit 403 sets the number of times of image capturing during the bracket image capturing to X times. In addition, the condition setting unit 403 sets the position of the image capturing lens 1101 corresponding to the in-focus position of the child 903 to a position P7.

In addition, the condition setting unit 403 sets the position of the image capturing lens 1101 corresponding to the in-focus position of the adult male 901 to the position P0. In addition, the condition setting unit 403 sets the position of the image capturing lens 1101 corresponding to the in-focus position of the adult female 902 to a position P8.

When the image capturing conditions are set, during the bracket image capturing processing (refer to FIG. 24), the lens control portion 1105 drives the image capturing lens 1101 from the position P0 to the margin position P5 on the closer side (S1501).

Next, when the first image capturing in the bracket image capturing is performed (S1503), the child 903 is set as the image capturing target (S1504). Further, the image capturing lens 1101 is driven by the interval drive amount A2 at the bracket intervals (S1505), and then the second image capturing is performed (S1507).

Thereafter, driving of the image capturing lens 1101 by the interval drive amount A2 (S1505) and image capturing (S1507) are repeated, and when the image capturing lens 1101 reaches the position P7 (Yes in S1508), it is judged that image capturing of the child 903 has been completed (S1509).

Further, since image capturing of the number of subjects selected by the user has not been completed (No in S1510), the adult male 901 is newly set as the image capturing target (S1504), and driving of the image capturing lens 1101 by the interval drive amount A2 (S1505) and image capturing (S1507) are repeated.

Moreover, after image capturing of the adult male 901 is completed, the adult female 902 is newly set as the image capturing target (S1504), and driving of the image capturing lens 1101 by the interval drive amount A2 (S1505) and image capturing (S1507) are repeated.

Further, when the image capturing lens 1101 reaches the position P8 (Yes in S1508), it is judged that image capturing of the adult female 902 has been completed (S1509). In addition, since image capturing of the number of subjects selected by the user has been completed (Yes in S1510), the bracket image capturing processing ends without performing image capturing when the dog 904 is at the in-focus position.

In the example shown in FIG. 25, it has been described that the bracket image capturing processing ends when the image capturing lens 1101 reaches the position P8, but it is not limited to this. The conditions for ending the bracket image capturing processing may be that the image capturing lens 1101 reaches the margin position P6 on the farther side.

### Fourth Embodiment

Next, the image capturing device 10 of Fourth Embodiment will be described. In Fourth Embodiment, during the bracket image capturing, the F-value (aperture value) in the image capturing device 10 is adjusted such that image capturing is performed in a state in which the part of the subject set in advance is at the in-focus position.

Regarding the image capturing device 10 of Fourth Embodiment, configurations different from those of First Embodiment to Third Embodiment will be described, and description of the same configuration as that in any of First Embodiment to Third Embodiment will be omitted.

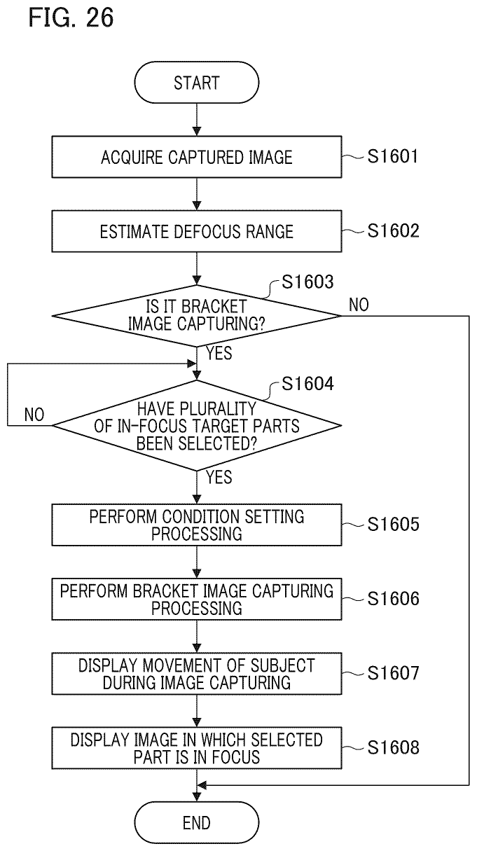

FIG. 26 is a flowchart showing another example of a flow of the condition image capturing processing in Fourth Embodiment. The processing in Step 1601 and Step 1602 of the condition image capturing processing shown in FIG. 26 is the same processing as the processing in Step 101 and Step 102 of the condition image capturing processing shown in FIG. 6.

The image capturing judgment unit 402 judges whether or not to perform the bracket image capturing using the image capturing device 10 on the basis of the range information generated in Step 1602 (S1603).

The image capturing judgment unit 402 focuses on the defocus amount of the part of the subject positioned on the closest side with respect to the image capturing device 10 and the defocus amount of the part of the subject positioned on the farthest side with respect to the image capturing device 10, among the defocus amounts identified from each piece of the generated range information.

In addition, when the position of a portion having the larger absolute value of the defocus amount of the two defocus amounts focused on is the in-focus position, the image capturing judgment unit 402 judges whether or not this in-focus position is the in-focus range of the image capturing lens 1101 included in the depth of field.

When the in-focus position is the in-focus range of the image capturing lens 1101 included in the depth of field, the image capturing judgment unit 402 judges that the bracket image capturing using the image capturing device 10 is to be performed. In addition, when the in-focus position is not the in-focus range of the image capturing lens 1101 included in the depth of field, the image capturing judgment unit 402 judges that the bracket image capturing is not to be performed using the image capturing device 10.

The image capturing judgment unit 402 may judge whether or not to perform the bracket image capturing using the image capturing device 10 by identifying the F-value at which the in-focus position determined as the judgment target is included in the depth of field and judging whether or not it is the in-focus range of the image capturing lens 1101 which can be adjusted to the identified F-value.

The condition setting unit 403 judges whether or not a plurality of focus target parts have been selected in the subject by the user (S1604). In the Embodiment, the bracket image capturing is performed in a state in which the part selected by the user in the subject is in focus.

The plurality of parts targeted for judgment in Step 1604 may be a plurality of parts in one subject or may be respective parts in a plurality of subjects. In addition, while a negative result continues in Step 1604 (No in S1604), the processing in Step 1604 is repeated.

In addition, when a plurality of parts are selected (Yes in S1604), the condition setting processing is performed (S1605). The details of the condition setting processing will be described below.

Next, the bracket image capturing processing is performed (S1606). The details of the bracket image capturing processing will be described below. In addition, the processing in Step 1607 and Step 1608 shown in FIG. 6 is the same processing as the processing in Step 106 and Step 108 of the condition image capturing processing.

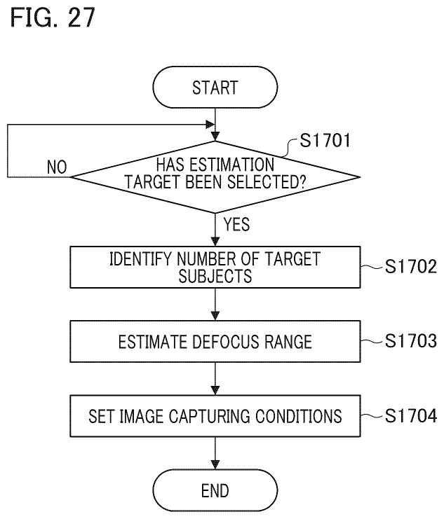

FIG. 27 is a flowchart showing another example of a flow of the condition setting processing in Fourth Embodiment (refer to S1605 in FIG. 26).

The condition setting unit 403 judges whether or not a target part for which the defocus range is estimated in the subject has been selected (S1701). A target part for which the defocus range is estimated in the subject may be selected by any technique, similar to selection of the target part set as the in-focus position in the subject. In addition, while a negative result continues (No in S1701), the processing in Step 1701 is repeated.

When a target part for which the defocus range is estimated is selected (Yes in S1701), the condition setting unit 403 identifies the number of subjects targeted for in-focus position setting from the captured image acquired in Step 1601 of the condition image capturing processing (refer to FIG. 26) (S1702). Here, for example, the subject for which the number of targets for the in-focus position setting is identified may be limited to a living being or the like.

The range estimation unit 401 estimates the defocus range for the part selected as a defocus range estimation target among the subjects selected as the targets for the in-focus position setting from the captured image, thereby generating the range information for each part of the subject (S1703).

The condition setting unit 403 sets the image capturing conditions for the bracket image capturing on the basis of the estimated defocus range in Step 1703 (S1704).

Examples of the image capturing conditions include the in-focus position, the position of the image capturing lens 1101 corresponding to the in-focus position, the bracket intervals, the range of the depth of field for each process of image capturing, the F-value for each process of image capturing, the number of times of image capturing, and the position of the image capturing lens 1101 when the bracket image capturing ends. For this reason, the condition setting unit 403 can also be regarded as a calculation means for calculating the range of the depth of field or the F-value during the bracket image capturing.

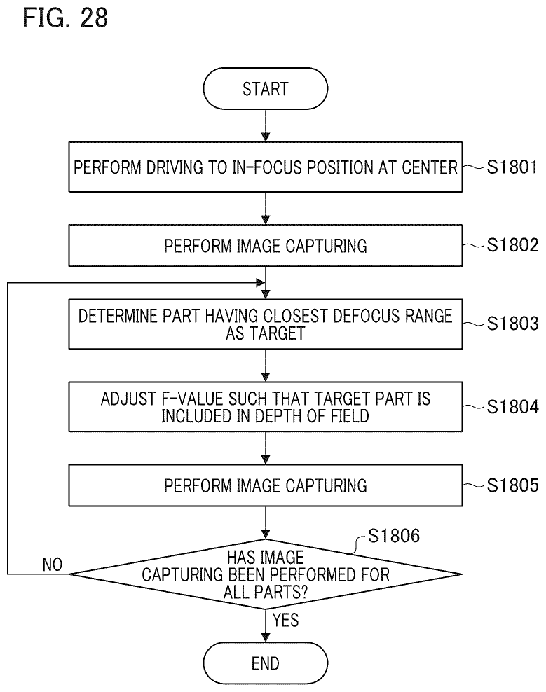

FIG. 28 is a flowchart showing another example of a flow of the bracket image capturing processing in Fourth Embodiment (refer to S1606 in FIG. 26).

The lens control portion 1105 drives the image capturing lens 1101 to a position corresponding to this in-focus position by setting the part having a size of the defocus range corresponding to the median value as the in-focus position, among the parts of the subjects targeted for image capturing during the bracket image capturing processing (S1801).

The size of the defocus range to be targeted for judgment may be the average value of the maximum value and the minimum value in the defocus range or may be the median value in the defocus range. In addition, the part having a size of the defocus range corresponding to the median value may hereinafter be referred to as a central part.

In addition, at this time, the lens control portion 1105 adjusts the F-value such that a part different from the central part is not included in the depth of field, among the parts of the subjects targeted for image capturing during the bracket image capturing processing. The image capturing unit 404 performs the first image capturing (S1802).

The lens control portion 1105 determines the part whose defocus range is closest to the central part as the target to be included in the depth of field, among the parts of the subjects targeted for image capturing and the parts not included in the depth of field (S1803).

The lens control portion 1105 adjusts the F-value such that the parts of the subjects determined as the targets in Step 1803 are included in the depth of field (S1804). That is, the lens control portion 1105 causes the image capturing target part to be newly included in the depth of field by adjusting the F-value without newly driving the image capturing lens 1101.

In addition, in this case, the F-value required to include this part in the depth of field is set depending on the defocus ranges of the parts of the subjects. The image capturing unit 404 performs the next image capturing (S1805).

The lens control portion 1105 judges whether or not image capturing of all image capturing target parts has been performed in the subjects (S1806).

When image capturing of all parts is not performed (No in S1806), the processing from Step 1803 is repeated. Accordingly, until image capturing of all image capturing target parts is performed, adjustment of the F-value and image capturing are performed in order from the part having the defocus range closer to the central part, among image capturing target parts.

In addition, when image capturing of all parts is performed (Yes in S1806), the bracket image capturing processing ends.

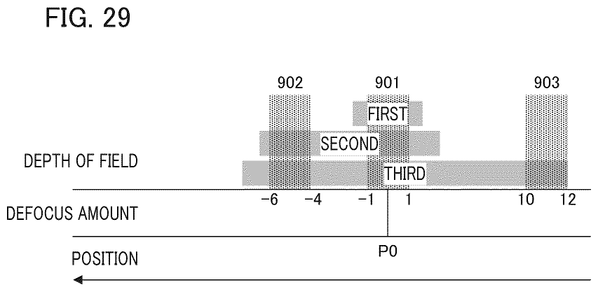

Next, a specific example of the bracket image capturing processing will be described. FIG. 29 is a diagram showing another example of a relationship between the subjects and the image capturing conditions for the bracket image capturing set by the condition setting unit 403. Hereinafter, the bracket image capturing processing executed when the captured image shown in FIG. 9 is obtained will be described.

In addition, hereinafter, it is assumed that the parts selected by the user as the focus target in the subjects are the face of the adult male 901, the face of the adult female 902, and the face of the child 903 in the condition setting processing. In addition, it is assumed that the defocus range estimated before the bracket image capturing processing starts is the same range as that in the example shown in FIG. 10.

During the bracket image capturing processing (refer to FIG. 28), the lens control portion 1105 sets the face of the adult male 901 to the in-focus position as the central part and drives the image capturing lens 1101 to the position P0 corresponding to this in-focus position (S1801).

Further, the first (first shot) image capturing is performed in a state in which the F-value is adjusted such that the face of the adult male 901 is included in the depth of field and the face of the adult female 902 and the face of the child 903 are not included in the depth of field (S1802).

Next, the lens control portion 1105 determines the face of the adult female 902 closer to the defocus range of the face of the adult male 901 as the target to be included in the depth of field (S1803), and adjusts the F-value such that the face of the adult male 901 and the face of the adult female 902 are included in the depth of field (S1804).

When the second (second shot) image capturing is performed in this state (S1805), the lens control portion 1105 determines the face of the child 903 as the target to be included in the depth of field (S1803). Further, in a state in which the F-value is adjusted such that the face of the adult male 901, the face of the adult female 902, and the face of the child 903 are included in the depth of field (S1804), third (third shot) image capturing is performed (S1805).

Accordingly, since image capturing of all image capturing target parts is performed (Yes in S1806), the bracket image capturing processing ends.

That is, in the example shown in FIG. 29, image capturing is performed three times (three shots). All of the positions of the image capturing lens 1101 during this image capturing performed three times are the position P0.

In the Embodiment, it has been described that the image capturing lens 1101 is not driven after the first image capturing is performed during the bracket image capturing processing, but it is not limited to this.

For example, in the example shown in FIG. 29, after the second image capturing is performed, the face of the child 903 may be set as the in-focus position, and the image capturing lens 1101 may be driven to a position corresponding to this in-focus position. Further, the third image capturing may be performed in a state in which the F-value is adjusted such that the face of the child 903 is included in the depth of field, and the face of the adult male 901 and the face of the adult female 902 are not included in the depth of field.

Next, fourth image capturing may be performed in a state in which the F-value is adjusted such that the image capturing lens 1101 is driven, the face of the child 903 and the face of the adult male 901 are included in the depth of field, and the face of the adult female 902 is not included in the depth of field.

Thereafter, the face of the adult female 902 may be set as the in-focus position, and the image capturing lens 1101 may be driven to a position corresponding to this in-focus position. Further, fifth image capturing may be performed in a state in which the F-value is adjusted such that the face of the adult female 902 and the face of the adult male 901 are included in the depth of field, and the face of the child 903 is not included in the depth of field.

Next, sixth image capturing may be performed in a state in which the F-value is adjusted such that the face of the adult female 902 is included in the depth of field, and the face of the child 903 and the face of the adult male 901 are not included in the depth of field. In addition, in this case, the second image capturing may be performed in a state in which the F-value is adjusted such that the face of the adult male 901, the face of the adult female 902, and the face of the child 903 are included in the depth of field.

In addition, in the disclosure, it has been described that the lens control portion 1105 drives the image capturing lens 1101 sequentially toward the farther side from the closer side with respect to the image capturing device 10 during the bracket image capturing processing, but it is not limited to this.

The lens control portion 1105 may drive the image capturing lens 1101 sequentially toward the closer side from the farther side with respect to the image capturing device 10.

In addition, in the disclosure, it has been described that the image capturing judgment unit 402 judges whether or not to perform the bracket image capturing in the condition image capturing processing (refer to FIG. 6 and the like).

Here, the system control unit 1002 may notify the user of whether or not to perform the bracket image capturing by causing the rear monitor 1009 or the like of the image capturing device 10 to display information indicating judgment results by the image capturing judgment unit 402.

As above, in the disclosure, the range estimation unit 401 acquires range information indicating the range of the defocus amounts corresponding to a plurality of subject parts being subjected to image capturing. Examples of subject parts include target parts.

In addition, examples of a plurality of subject parts being subjected to image capturing include a plurality of target parts in a live view image. In addition, examples of the ranges of the defocus amounts corresponding to a plurality of subject parts include defocus ranges of a plurality of respective target parts.

In addition, the condition setting unit 403 sets a plurality of image capturing conditions for capturing images in which the plurality of subject parts are in focus on the basis of the range information. Further, the image capturing unit 404 performs a plurality of times of image capturing on the basis of the plurality of image capturing conditions.

In this case, even when the defocus amount varies depending on the portion of the subject part, images in which the plurality of subject parts are in focus are captured.

In addition, the range estimation unit 401 estimates the ranges of the defocus amounts corresponding to the plurality of subject parts. In this case, even when defocus amount varies depending on the portion of the subject part, images in which the plurality of subject parts are in focus are captured on the basis of estimation results of the range estimation unit 401.

In addition, the image capturing judgment unit 402 judges whether or not to perform a plurality of times of image capturing on the basis of the range information, and the plurality of times of image capturing are bracket image capturing in which the in-focus position varies depending on image capturing. In this case, whether or not to perform the bracket image capturing in which the in-focus position varies depending on image capturing is switched depending on the ranges of the defocus amounts corresponding to the plurality of subject parts.

In addition, the condition setting unit 403 calculates the drive range of the image capturing lens on the basis of the defocus amount corresponding to the part on the closest side and the defocus amount corresponding to the part on the farthest side during the bracket image capturing.

The part on the closest side is a part closest to the image capturing device 10 among the plurality of subject parts. In addition, the part on the farthest side is a part at a position farthest from the image capturing device 10 among the plurality of subject parts.

Further, the image capturing judgment unit 402 judges whether or not to perform the bracket image capturing on the basis of the relationship between the drive range of the image capturing lens 1101 calculated by the condition setting unit 403 and the in-focus range of the image capturing lens 1101.

In this case, whether or not to perform the bracket image capturing is switched depending on the relationship between the drive range of the image capturing lens 1101 calculated by the condition setting unit 403 and the in-focus range of the image capturing lens 1101.

In addition, the image capturing judgment unit 402 judges whether or not to perform a plurality of times of image capturing on the basis of the range information, and the plurality of times of image capturing are the bracket image capturing in which the F-value varies depending on image capturing.

In this case, whether or not to perform the bracket image capturing in which the F-value varies depending on image capturing is switched depending on the ranges of the defocus amounts corresponding to the plurality of subject parts.

In addition, the condition setting unit 403 calculates the range of the depth of field or the F-value during the bracket image capturing on the basis of the defocus amount corresponding to the part on the closest side and the defocus amount corresponding to the part on the farthest side.

The part on the closest side is a part closest to the image capturing device 10 among the plurality of subject parts. In addition, the part on the farthest side is a part at a position farthest from the host device among the plurality of subject parts.

Further, the image capturing judgment unit 402 judges whether or not to perform the bracket image capturing on the basis of the relationship between the range of the depth of field or the F-value calculated by the condition setting unit 403 and the in-focus range of the image capturing lens 1101.

In this case, whether or not to perform the bracket image capturing is switched depending on the relationship between the range of the depth of field or the F-value calculated by the condition setting unit 403 and the in-focus range of the image capturing lens 1101.

In addition, the plurality of image capturing conditions include at least one of the drive amount of the image capturing lens 1101, the number of times of image capturing, the position of the image capturing lens 1101 when the plurality of times of image capturing end, the bracket intervals, and the F-value.

In this case, even when the defocus amount varies depending on a portion of the subject parts, since the conditions described above are set as at least one of the plurality of image capturing conditions on the basis of the range information, images in which the plurality of subject parts are in focus are captured.

In addition, the plurality of times of image capturing are bracket image capturing, and the plurality of image capturing conditions include the drive amount of the image capturing lens 1101. Further, the condition setting unit 403 sets the drive amount of the image capturing lens 1101 on the basis of the defocus amount corresponding to the part closest to the image capturing device 10 among the plurality of subject parts or the part at a position farthest from the image capturing device 10 among the plurality of subject parts.

In this case, images in which the part closest to the image capturing device 10 among the plurality of subject parts or the part at a position farthest from the image capturing device 10 among the plurality of subject parts is in focus are captured.

In addition, the plurality of subject parts are parts selected in advance, and the plurality of image capturing conditions include the drive amount of the image capturing lens. Further, the condition setting unit 403 sets the drive amount of the image capturing lens 1101 on the basis of the defocus amount corresponding to the part closest to the image capturing device 10 among the plurality of subject parts or the part at a position farthest from the image capturing device 10 among the plurality of subject parts. In this case, images in which the parts selected in advance are in focus are captured.

In addition, the plurality of image capturing conditions include the position of the image capturing lens 1101 when the plurality of times of image capturing end, or the number of times of image capturing. Further, the condition setting unit 403 sets the position of the image capturing lens 1101 when the plurality of times of image capturing end or the number of times of image capturing on the basis of the number of target subjects of the plurality of subject parts and the defocus amount corresponding to the part on the closest side or the part on the farthest side.

The part on the closest side is a part closest to the image capturing device 10 among the plurality of subject parts. In addition, the part on the farthest side is a part at a position farthest from the image capturing device 10 among the plurality of subject parts.

In this case, since the image capturing conditions are set on the basis of the number of target subjects of the plurality of subject parts and the defocus amount corresponding to the part on the closest side or the part on the farthest side, images in which the plurality of subject parts are in focus are captured.

In addition, the plurality of subject parts are parts selected in advance, and the plurality of image capturing conditions include the bracket interval or the F-value when the plurality of times of image capturing are the bracket image capturing. Further, the condition setting unit 403 (setting means) sets the bracket interval or the F-value on the basis of the range information.

In this case, since the bracket interval or the F-value is set as the image capturing conditions on the basis of the range information, images in which the plurality of subject parts are in focus are captured.

In addition, the plurality of image capturing conditions include the number of times of image capturing. Further, the condition setting unit 403 sets the number of times of image capturing on the basis of the defocus amount corresponding to the part on the closest side and the defocus amount corresponding to the part on the farthest side. The part on the closest side is a part closest to the image capturing device 10 among the plurality of subject parts.

In addition, the part on the farthest side is a part at a position farthest from the image capturing device 10 among the plurality of subject parts. In this case, since the number of times of image capturing is set on the basis of the defocus amount corresponding to the part on the closest side and the defocus amount corresponding to the part on the farthest side, images in which the plurality of subject parts are in focus are captured.

In addition, the plurality of times of image capturing are bracket image capturing, and the plurality of image capturing conditions include the subject range during the bracket image capturing. Further, the condition setting unit 403 sets the margin position on the closer side or the margin position on the farther side on the basis of the interval drive amount.

In other words, the condition setting unit 403 sets an area closer to the host device than the part on the closest side or an area farther from the host device than the part on the farthest side as the subject range during the bracket image capturing on the basis of the interval drive amount.

The part on the closest side is a part closest to the image capturing device 10 among the plurality of subject parts. In addition, the part on the farthest side is a part at a position farthest from the image capturing device 10 among the plurality of subject parts. In this case, even when an error occurs in the defocus range or driving of the image capturing lens 1101, it becomes easier to capture images in which the plurality of subject parts are in focus.

While the disclosure has been described with reference to embodiments, it is to be understood that the disclosure is not limited to the disclosed embodiments. The scope of the following claims is to be accorded the broadest interpretation so as to encompass all such modifications and equivalent structures and functions.

In addition, as a part or the whole of the control according to the embodiments, a computer program realizing the function of the embodiments described above may be supplied to the image processing device or the like through a network or various storage media. Then, a computer (or a CPU, an MPU, or the like) of the image processing device or the like may be configured to read and execute the program. In such a case, the program and the storage medium storing the program configure the disclosure.

In addition, the disclosure includes those realized using at least one processor or circuit configured to perform functions of the embodiments explained above. For example, a plurality of processors may be used for distribution processing to perform functions of the embodiments explained above.

This application claims the benefit of Japanese Patent Application No. 2025-020340, filed on Feb. 10, 2025, which is hereby incorporated by reference herein in its entirety.

What is claimed is:

1. A processing device comprising:
at least one processor; and
at least one memory coupled to the at least one processor, the at least one memory storing instructions that, when executed by the at least one processor, cause the at least one processor to:
acquire range information indicating a range of defocus amounts corresponding to a plurality of subject parts being subjected to image capturing,
set a plurality of image capturing conditions for capturing images in which the plurality of subject parts are in focus based on the range information, and
perform a plurality of times of image capturing based on the plurality of image capturing conditions.

2. The processing device according to claim 1,
wherein the at least one memory stores further instructions that, when executed by the at least one processor, cause the at least one processor to:
estimate the range of the defocus amounts corresponding to the plurality of subject parts.

3. The processing device according to claim 1,
wherein the at least one memory stores further instructions that, when executed by the at least one processor, cause the at least one processor to:
judge whether or not to perform the plurality of times of image capturing based on the range information, and
the plurality of times of image capturing are bracket image capturing in which an in-focus position varies depending on image capturing.

4. The processing device according to claim 3,
wherein the at least one memory stores further instructions that, when executed by the at least one processor, cause the at least one processor to:
calculate a drive range of an image capturing lens during the bracket image capturing based on the defocus amount corresponding to a part of the plurality of subject parts closest to a host device, and the defocus amount corresponding to a part of the plurality of subject parts at a position farthest from the host device, and
whether or not to perform the bracket image capturing is judged based on a relationship between the drive range of the image capturing lens and an in-focus range of the image capturing lens.

5. The processing device according to claim 1,
wherein the at least one memory stores further instructions that, when executed by the at least one processor, cause the at least one processor to:
judge whether or not to perform the plurality of times of image capturing based on the range information, and
the plurality of times of image capturing are bracket image capturing in which an F-value varies depending on image capturing.

6. The processing device according to claim 5,
wherein the at least one memory stores further instructions that, when executed by the at least one processor, cause the at least one processor to:
calculate a range of a depth of field or the F-value during the bracket image capturing based on the defocus amount corresponding to a part of the plurality of subject parts closest to a host device, and the defocus amount corresponding to a part of the plurality of subject parts at a position farthest from the host device, and
whether or not to perform the bracket image capturing is judged based on a relationship between the range of the depth of field or the F-value and an in-focus range of the image capturing lens.

7. The processing device according to claim 1,
wherein the plurality of image capturing conditions include at least one of a drive amount of an image capturing lens, the number of times of image capturing, a position of the image capturing lens when the plurality of times of image capturing have ended, a time interval between the end of one process of image capturing and the start of next image capturing when the plurality of times of image capturing are bracket image capturing, and an F-value.

8. The processing device according to claim 7,
wherein the plurality of times of image capturing are the bracket image capturing,
the plurality of image capturing conditions include the drive amount of the image capturing lens, and
the drive amount of the image capturing lens is set based on the defocus amount corresponding to a part of the plurality of subject parts closest to a host device or a part of the plurality of subject parts at a position farthest from the host device.

9. The processing device according to claim 7,
wherein the plurality of subject parts are parts selected in advance,
the plurality of image capturing conditions include the drive amount of the image capturing lens, and
the drive amount of the image capturing lens is set based on the defocus amount corresponding to a part of the plurality of subject parts closest to a host device or a part of the plurality of subject parts at a position farthest from the host device.

10. The processing device according to claim 7,
wherein the plurality of image capturing conditions include a position of the image capturing lens when the plurality of times of image capturing have ended, or the number of times of image capturing, and
the position of the image capturing lens when the plurality of times of image capturing have ended, or the number of times of image capturing is set based on the number of target subjects of the plurality of subject parts, and the defocus amount corresponding to a part of the plurality of subject parts closest to a host device or a part of the plurality of subject parts at a position farthest from the host device.

11. The processing device according to claim 7,
wherein the plurality of subject parts are parts selected in advance,
the plurality of image capturing conditions include the time interval or the F-value when the plurality of times of image capturing are the bracket image capturing, and
the time interval or the F-value is set based on the range information.

12. The processing device according to claim 7,
wherein the plurality of image capturing conditions include the number of times of image capturing, and
the number of times of image capturing is set based on the defocus amount corresponding to a part of the plurality of subject parts closest to a host device, and the defocus amount corresponding to a part of the plurality of subject parts at a position farthest from the host device.

13. The processing device according to claim 1,
wherein the plurality of times of image capturing are bracket image capturing,
the plurality of image capturing conditions include a subject range during the bracket image capturing, and
an area closer to the host device than the part of the plurality of subject parts closest to a host device, or an area farther from the host device than the part of the plurality of subject parts at a position farthest from the host device is set as the subject range during the bracket image capturing based on the drive amount of the image capturing lens between the end of one process of image capturing and the start of next image capturing during the bracket image capturing.

14. A method for controlling a processing device, the method comprising:
acquiring range information indicating a range of defocus amounts corresponding to a plurality of subject parts being subjected to image capturing,
setting a plurality of image capturing conditions for capturing images in which the plurality of subject parts are in focus based on the range information, and
performing a plurality of times of image capturing based on the plurality of image capturing conditions.

15. The method according to claim 14, further comprising:
estimating the range of the defocus amounts corresponding to the plurality of subject parts.

16. The method according to claim 14, further comprising:
judging whether or not to perform the plurality of times of image capturing based on the range information,
wherein the plurality of times of image capturing are bracket image capturing in which an in-focus position varies depending on image capturing.

17. A non-transitory computer-readable storage medium storing a program for causing a computer to execute a method, the method comprising:
acquiring range information indicating a range of defocus amounts corresponding to a plurality of subject parts being subjected to image capturing,
setting a plurality of image capturing conditions for capturing images in which the plurality of subject parts are in focus based on the range information, and
performing a plurality of times of image capturing based on the plurality of image capturing conditions.

18. The non-transitory computer-readable storage medium according to claim 17, further comprising:
estimating the range of the defocus amounts corresponding to the plurality of subject parts.

19. The non-transitory computer-readable storage medium according to claim 17, further comprising:
judging whether or not to perform the plurality of times of image capturing based on the range information,
wherein the plurality of times of image capturing are bracket image capturing in which an in-focus position varies depending on image capturing.
